(19) United States
(12) Patent Application Publication
(10) Pub. No.: US 2020/0159323 A1
(43) Pub. Date: May 21, 2020

(54) NEURAL OPERATING SYSTEM

(71) Applicant: NURO CORP., Guelph (CA)

(72) Inventors: Francois Gand, Guelph (CA); Abhinav Kumar, Dhoomanganj, Allahabad (IN)

(21) Appl. No.: 16/616,104

(22) PCT Filed: Jun. 15, 2018
(86) PCT No.: PCT/CA2018/000121

§ 371 Date: Nov. 22, 2019

Related U.S. Application Data
(60) Provisional application No. 62/520,194, filed on Jun. 15, 2017.

(51) Int. Cl. G06F 3/01; G06N 20/00; G06N 5/04

(52) U.S. Cl. CPC G06F 3/015; G06N 5/04; G06N 20/00

(57) ABSTRACT

Methods of and systems for human interactions with a computer operating system using neurological signals from a human brain are described. In one embodiment, the system comprises a modified computer operating system and a method of capturing, reading and interpreting live human brain-based signals to navigate throughout, interact with and operate the computer operating system without the need of a traditional computer keyboard, computer mouse or other past or current computer operating system natively-supported input methods, and also without the need for any electronic hardware device calibration per end-user or software calibration per end-user and without the need for any preliminary brain state recording or any neurological signal training within the computer operating system.

### CROSS REFERENCE TO RELATED APPLICATIONS

This application claims the benefit of U.S. provisional application 62/520,194, of the same title, filed Jun. 15, 2017, which is hereby incorporated by reference in its entirety.

### FIELD

The present application relates generally to computing systems using human-electronics interfaces and more specifically to the human brain interacting with a computer system.

### BACKGROUND

From 1951 to the current day, computer operating systems have required humans to generate and use input methods to allow any data to be received as computer-compatible input for human-to-computer interaction to be generated.

Prominently, for the human to use a computer operating system, the computer operating system had to natively support this interaction relying on the input method between a computer operating system and a computer-based hardware or computer software namely a computer keyboard, computer mouse, computer stylus, computer interactive pen display, human eyes-based touch typing, human hands-based touch typing, human hands-based motion gestures, human forearm-based motion gestures, human muscle memory-based automated inputs, motion-tracked controllers, sound-based controllers, object recognition systems, context-sensitive word-prediction systems or context-sensitive dynamic abbreviation expansion systems. These approaches are cumbersome and require significant learning periods and physical effort from users.

### SUMMARY

Computer operating systems until now have not been primarily architected nor intrinsically-designed to support or respond to live human brain-based input methods. Therefore there is a need for a new computer operating system and computer user interfacing able to interact directly and strictly with the human brain as its sole method of operation without any typing, clicking, swiping, human head-tracking or body motion-tracking or inputting of any other kind.

Some aspects relate to a computing system which includes one or more processors, computer-readable storage media, display devices, and the like, and communicatively coupled to a data source or sensors which provide brain-related data from a user. The computing system may execute an operating system or other software that permits any human being to interact with this computer operating system strictly via a human brain-based live input methodology. This novel interaction is facilitated by a computer user interface programmed to respond to the analog-to-digital conversion and analysis of the electroencephalographic, electromyographic and electrooculographic signal transmissions emitted by the human brain, surrounding cranium and the neuromuscular activity of the human eyes.

In some embodiments, the neural operating system embodies a hardware-agnostic intelligent data access computing paradigm and manages the human-to-computer and computer-to-human interactions via an innovative computer user interface designed to allow for a faster and more streamlined use and navigation of the computer operating system without any need for end-user-based hardware calibration or software calibration nor any preliminary brain state recording per end-user nor any neurological signal training within the computer operating system.

In some embodiments, the computer operating system may additionally integrate machine-learning algorithms and programmed automations which learn, assimilate, record, archive, modify, customize, organize and present for the end-user pre-categorized content matching the specific end-user's preferences based on any single one or combination of the following parameters:
(i) the end-user's demographic data
(ii) the end-user-based pattern recognitions of the computer operating system navigation
(iii) the end-user-based pattern recognitions of the computer operating system usage trends
(iv) the frequency and repetition levels of identical or similarly-accessed content by the end-user
(v) the prioritization of content based on the end-user's physical health at the time of interaction between the end-user and the computer operating system
(vi) the prioritization of content based on the end-user's mental health at the time of interaction between the end-user and the computer operating system
(vii) the prioritization of content based on the end-user's intellectual health at the time of interaction between the end-user and the computer operating system
(viii) the status of independent physiological functioning or physiological functioning via assisted caregiving receivership or under medical supervision
(ix) the end-user professional qualifications
(x) the end-user professional activity
(xi) the end-user professional activity at the time of interaction between the end-user and the computer operating system
(xii) the time of day, week, month and year
(xiii) the end-user temperature
(xiv) the environmental temperature surrounding the end-user
(xv) the physical geographic location of the end-user.

In some embodiments, there is provided a computing device or computing system which executes a device-agnostic computer operating system using static and/or dynamic machine-learning algorithmic-generated and managed programmed computer graphic user interfaces which are designed and architected for any human being to interact with. The operating system may operate and receive inputs via the analysis of human brain-based live or recorded neurological signals. Some aspects may incorporate and/or cooperate with one or more of computer hardware and electronic devices, electronic wireless data transmission protocols, external graphic processing units, external graphic electronic displays, non-transitory computer-readable storage media, and bio-sensor apparatus coupled to the end-user's human head for capturing the human brain-based live neurological signals being transmitted live to the computer operating system.

### BRIEF DESCRIPTION OF THE DRAWINGS

The accompanying drawings, which are included to provide a further understanding of the disclosed subject matter, are incorporated in and constitute a part of this specification. The drawings also illustrate example implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

As used herein, the expression “illustrative” may refer to example or exemplary embodiments. In the figures, which illustrate example embodiments:

FIG. 1 is an illustrative schematic diagram of an example graphic user interface of a computer operating system;

FIG. 2 is an illustrative schematic diagram of the computer operating system's graphical user interface highlighting Interactive Zone 0 in a Standard Operational Mode (108);

FIG. 3 is an illustrative schematic diagram of the computer operating system's graphical user interface highlighting Interactive Zone 1 in a Standard Operational Mode (109);

FIG. 4 is an illustrative schematic diagram of the computer operating system's graphical user interface highlighting Machine Learning Zone 2 in a Standard Operational Mode (110);

FIG. 5 is an illustrative schematic diagram of the computer operating system's graphical user interface highlighting Machine Learning Zone 2 in a Grid Mode (111);

FIG. 6 is an illustrative schematic diagram of the computer operating system's graphical user interface highlighting Machine Learning Zone 3 in a Standard Operational Mode (112);

FIG. 7 is an illustrative schematic diagram of the computer operating system's graphical user interface highlighting Machine Learning Zone 3 in a Grid Mode (111);

FIG. 8 is an illustrative schematic diagram of the computer operating system's graphical user interface highlighting Interactive Zone 4 in a Radar Operational Mode (114);

FIG. 9 is an illustrative schematic diagram of Interactive Zone 4 in a Radar Operational Mode (114);

FIG. 10 is an illustrative schematic diagram of Interactive Zone 4 in a Radar Operational Mode (114);

FIG. 11 is a sequential series of illustrative schematic diagrams of Interactive Zone 4 in a Radar Operational Mode (114);

FIG. 12 is an illustrative schematic diagram of the computer operating system's graphical user interface highlighting Interactive Zone 5 in a Radar Operational Mode (127);

FIG. 13 is an illustrative schematic diagram of Interactive Zone 5 in a Radar Operational Mode (127) including an interactive graphic circle element;

FIG. 14 is an illustrative schematic diagram of Interactive Zone 5 in a Radar Operational Mode (127) with the graphic circle element (129) fully slid along the interactive graphic line element;

FIG. 15 is an illustrative schematic diagram of the computer operating system's graphical user interface highlighting Interactive Zone 6 in a Standard Operational Mode (136);

FIG. 16 is an illustrative schematic diagram of the computer operating system's graphical user interface highlighting Interactive Zone 7 in a Standard Operational Mode (137);

FIG. 17 is an illustrative diagram of an example implementation of the computer operating system (138) displayed in a computer monitor or television (139) via a wired video cable connection (140) to a conventional desktop personal computer device (141);

FIG. 18 is an illustrative diagram of an example implementation of the computer operating system (145) displayed in a computer monitor or television (144) with a direct physical Universal Serial Bus (also known as USB) connection to a portable small form factor computing device (such as the Intel Compute Stick) (146);

FIG. 19 is an illustrative diagram of an example implementation of the computer operating system (150) displayed in an Internet-ready wirelessly-connected television (also known as a Smart TV appliance) (149);

FIG. 20 is an illustrative diagram of an example implementation of the computer operating system (153) displayed on a physical wall or a standard projection screen (154) via an Internet-ready wirelessly-connected projector device (also known as a Smart Projector appliance) (156);

FIG. 21 is an illustrative diagram of an example implementation of the computer operating system (159) displayed in an Internet-ready or communication network-ready wirelessly-connected tablet computer;

FIG. 22 is an illustrative flowchart of example internal components of the computing system and associated software and the interactivity between each of these components based on all systems and methods presented herein;

FIG. 23 is an illustrative flowchart of the relationship between the neurological data by the computing system and associated responses;

FIG. 24 is a schematic diagram of an example of a responsive state interface upgrade for a radar-like virtual keyboard;

FIG. 25 is a schematic diagram of an example of a responsive state interface upgrade for a radar-like virtual keyboard;

FIG. 26 is a schematic diagram of three examples of responsive state interface upgrades for facilitated alpha-numerical entries by the radar-like virtual keyboard into an Interactive Zone in the computer operating system;

FIG. 27 is a schematic diagram of three examples of responsive state interface upgrades; and

FIG. 28 is a block diagram depicting components of an example computing device which can perform the systems and methods described herein.

### DETAILED DESCRIPTION

In the following description, specific details are set forth in order to provide a thorough understanding of the disclosed example embodiments. However, one skilled in the art will recognize that embodiments may be practiced without one or more of these specific details or with other methods, and that these embodiments are merely examples and the scope of the invention is not limited to the specific embodiments described herein.

In other instances, well-known structures associated with electronic devices, and in particular analog-to-digital converters and wireless transmitters or wearable electronics, such as bluetooth-enabled devices, wearable headsets comprising of any type of bio-signal measuring sensor, electroencephalogram devices, cameras for communication over a data network, global positioning systems (GPS), have not been described in detail to avoid unnecessarily obscuring descriptions of the embodiments.

Unless the context requires otherwise, throughout the specification and claims, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature or characteristic may be combined in any suitable manner in one or more embodiments.

As used in this specification and the appended claims, the singular forms “a”, “an” and “the” include plural referents unless the content indicates differently. It is to be noted that the term “or” is generally employed in its broadest sense, that is as meaning “and/or” unless the content dictates otherwise.

The headings and Abstract provided herein are for formal compliance only and do not limit or inform the scope or meaning of the claims or embodiments described herein.

Various embodiments described herein provide methods of and systems for human-computer interactions with a computing system which includes an operating system configured to accept transmitted neurological signals from an end-user's human-brain as inputs.

Throughout this specification and the appended claims, the presented description shall be considered as an example of computing system specially configured to provide an implementable architecture for human-computer interactions with an operating system using transmitted neurological signals from an end-user's human-brain and the operating system having a representable human-computer interface presented to the end-user. However, a person of skill in the art will appreciate that the various teachings described herein may be applied in various other forms and/or related designs for an end-user.

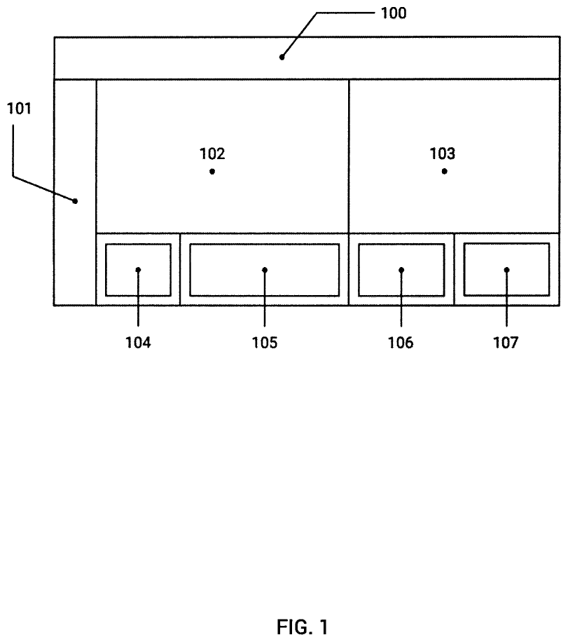

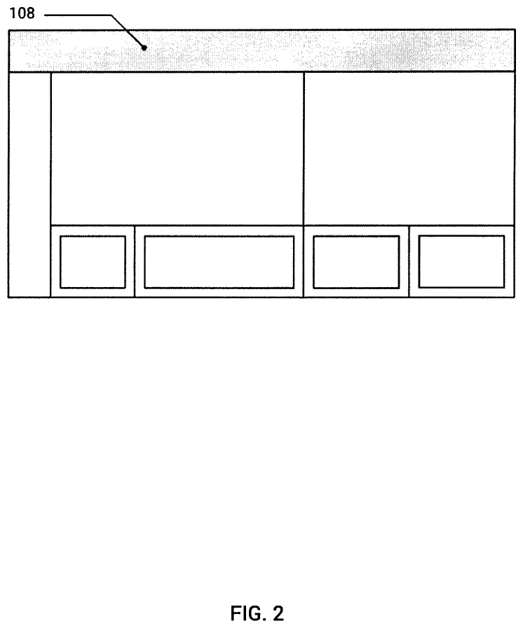

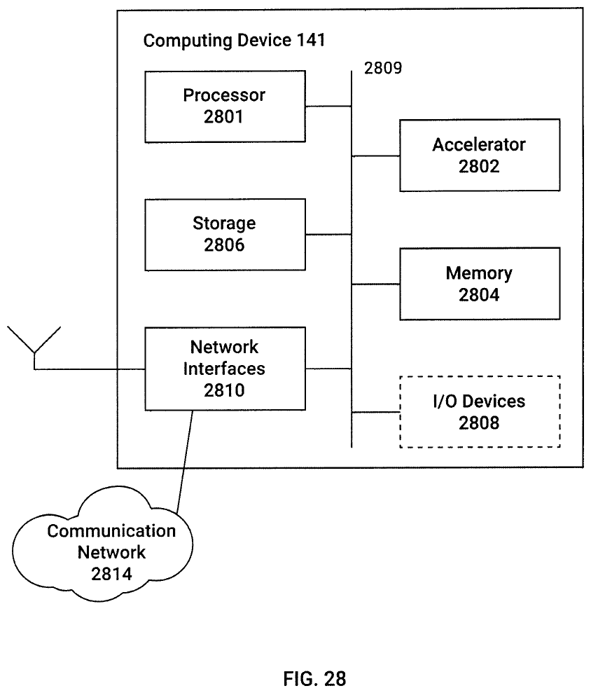

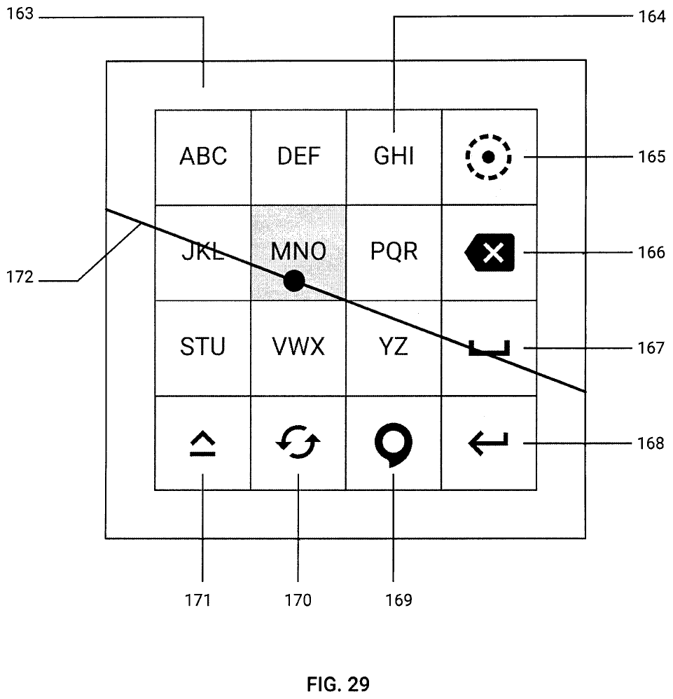

FIG. 1 is an illustrative schematic diagram of an example graphical user interface (GUI) of a computer operating system. The GUI may be presented to the user as part of, for example, an operating system executing in memory of a computing device 141 (as shown in FIG. 28). The GUI may be presented, for example, on a display device (e.g. a monitor, a projector, a mobile phone touchscreen or tablet touchscreen, or the like) of the computing device 141 or communicatively coupled to the computing device 141. The operating system may utilize human brain-based neurological signals as inputs. That is, the human brain-based neurological signals may be used to at least one of control, navigate and operate the computer operating system and at least one of display, generate, prioritize static and dynamically-generated algorithmic content for human-computer interactions via eight pre-programmed areas (depicted as interactive zones 100-107 in FIG. 1) in the system's architecture in accordance with the present systems, articles and methods. It will be appreciated that there are 8 pre-programmed areas in the GUI of FIG. 1.

In some embodiments, the human brain-based neurological signals may include at least one of EEG, EMG and EOG signals. One, two or three of the aforementioned signals may be used by the operating system as inputs, either synchronously or asynchronously. These signals may be obtained from hardware-based sensing device placed on a human user's head. For example, the sensors may be placed on one or more of the frontal part of a human head or in one or more of the Fp1, Fpz, Fp2 and/or N1h, Nz, N2h and/or nasal bridge areas of the human head. It will be appreciated that other areas of the head are possible depending on the sensing devices used and the sensitivities of the devices associated therewith.

In some embodiments, one or more of the 8 pre-programmed areas are operated in a so-called standard operating mode. In other embodiments, one or more pre-programmed areas are operated in a so-called “grid mode”. In still other embodiments, one or more pre-programmed areas are operated in a so-called “radar mode”. These modes are further described below. Although the present example embodiments show 8 interactive zones, a person skilled in the art will appreciate that other embodiments may include more or less than 8 interactive zones.

In one aspect of the invention, and as shown in FIG. 1, the neural operating system is a computer operating system which presents a GUI to the user which includes eight Interactive Zones (100) (101) (102) (103) (104) (105) (106) (107) providing neurological data management, neurological data representation, static content management, machine-learning-based algorithmically-generated content creation, sorting and display, navigation, interfacing and control of the computer operating system.

The eight Interactive Zones (100) (101) (102) (103) (104) (105) (106) (107) operate independently from one another, and may also operate in concert based on an end-user's executed request for processing. The state of each Interactive Zone is able to change based on the end-user's executed request for processing via the received transmission, processing and management of the end-user's human brain-based neurological signals.

FIG. 2 is an illustrative schematic diagram of the computer operating system's graphical user interface highlighting Interactive Zone 0 in a Standard Operational Mode (108).

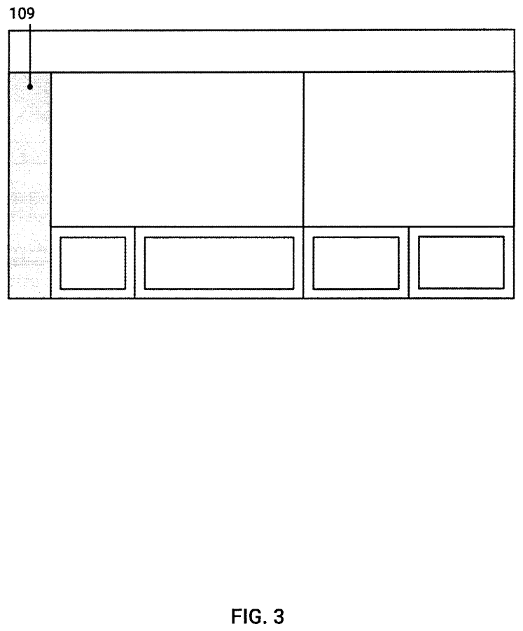

FIG. 3 is an illustrative schematic diagram of the computer operating system's graphical user interface highlighting Interactive Zone 1 in a Standard Operational Mode (109).

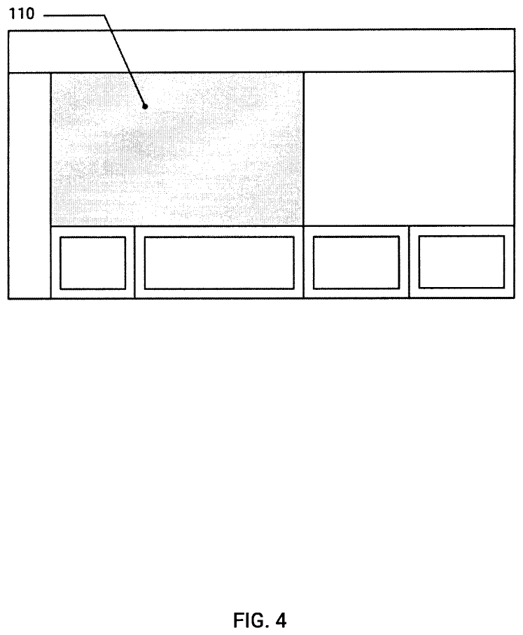

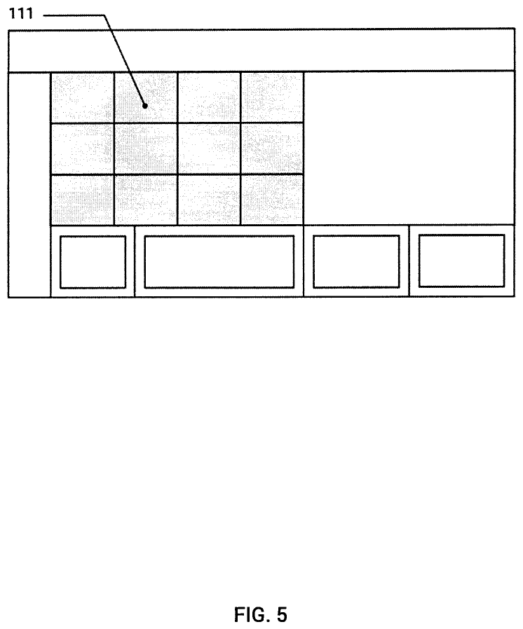

FIG. 4 is an illustrative schematic diagram of the computer operating system's graphical user interface highlighting Machine Learning Zone 2 in a Standard Operational Mode (110).

FIG. 5 is an illustrative schematic diagram of the computer operating system's graphical user interface highlighting Machine Learning Zone 2 in a Grid Mode (111).

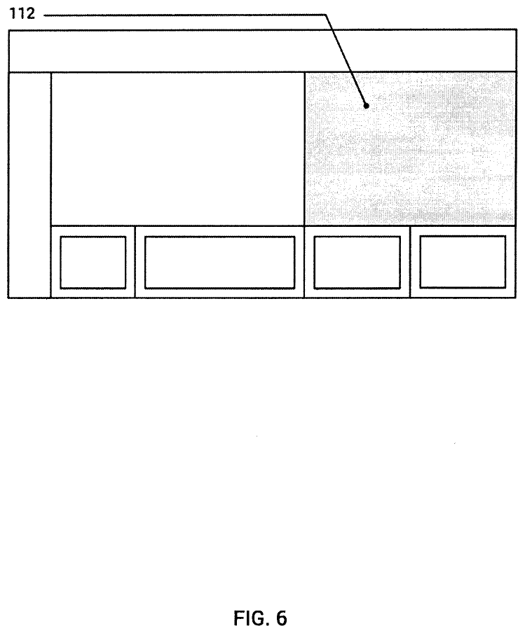

FIG. 6 is an illustrative schematic diagram of the computer operating system's graphical user interface highlighting Machine Learning Zone 3 in a Standard Operational Mode (112).

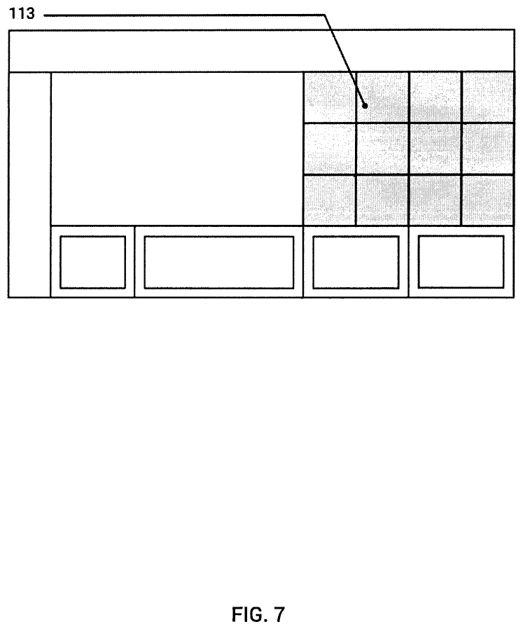

FIG. 7 is an illustrative schematic diagram of the computer operating system's graphical user interface highlighting Machine Learning Zone 3 in a Grid Mode (111).

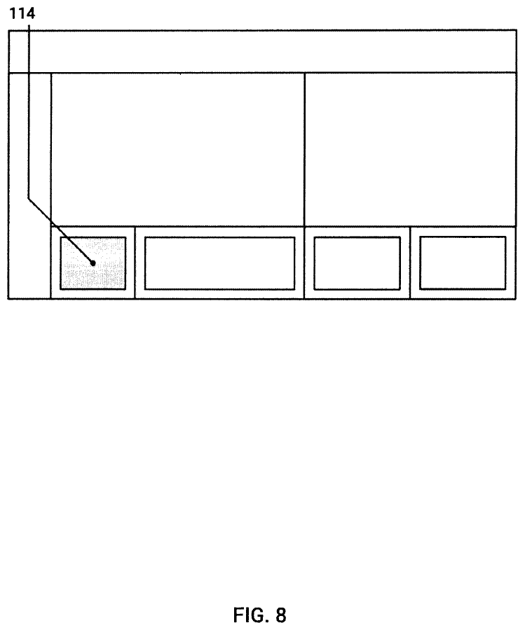

FIG. 8 is an illustrative schematic diagram of the computer operating system's graphical user interface highlighting Interactive Zone 4 in a Radar Operational Mode (114).

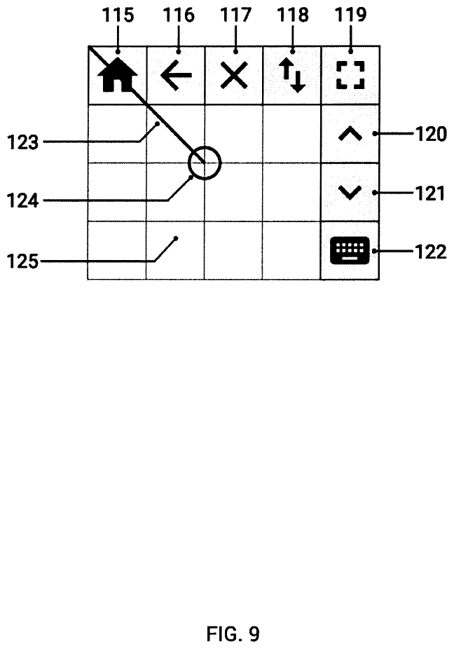

FIG. 9 is an illustrative schematic diagram of Interactive Zone 4 in a Radar Operational Mode (114) with twenty interactive areas including an innovative neurologically-responsive control system comprised of eight navigational cells (115) (116) (117) (118) (119) (120) (121) (122), twelve grid-control cells (125), an independent clockwise-rotating radar-like interactive graphic line element (123) and an interactive graphic circle element able to slide, stop sliding or continue sliding within the directional path of the interactive graphic line (124). It will be appreciated that in other embodiments, there are more or less than 8 navigational cells and more or less than 20 interactive areas. Further, the radar-like interactive graphic line element 123 may rotate counterclockwise.

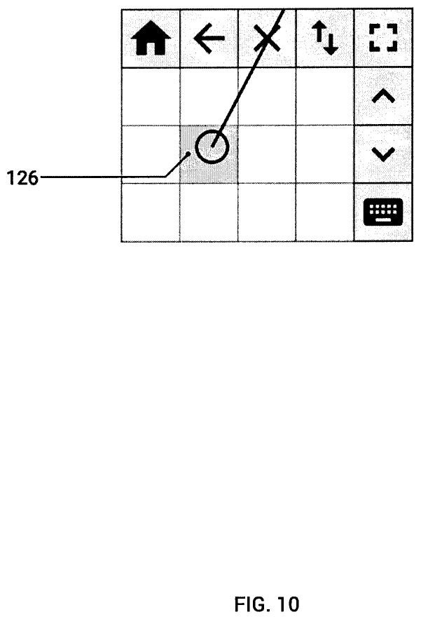

FIG. 10 is an illustrative schematic diagram of Interactive Zone 4 in a Radar Operational Mode (114) with the independent interactive graphic circle element (124) fully slid along the interactive graphic line element (123) and able to launch and execute subroutine-nested computer code via human brain-based neurological signals by activating one two-dimensionally- and spatially-placed grid-control cell (126) out of the twelve grid-control cells (125).

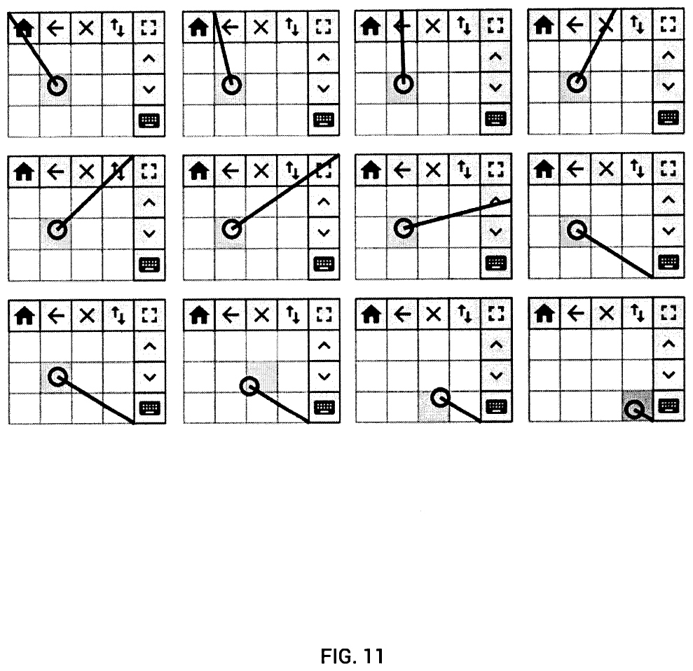

FIG. 11 is a sequential series of illustrative schematic diagrams of Interactive Zone 4 in a Radar Operational Mode (114) with various states over time demonstrating the clockwise rotation of the radar-like interactive graphic line element (123) and the physical translation of the interactive graphic circle element (124) along the directional path of the interactive graphic line (123) from one grid-control cell (125) to another grid-control cell (125) within the area of Interactive Zone 4 (114) upon activation via human-brain-based neurological signals.

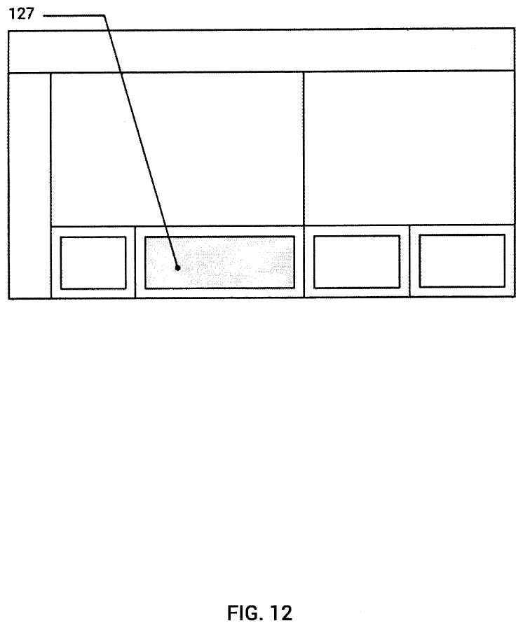

FIG. 12 is an illustrative schematic diagram of the computer operating system's graphical user interface highlighting an area referred to as Interactive Zone 5 in a Radar Operational Mode (127).

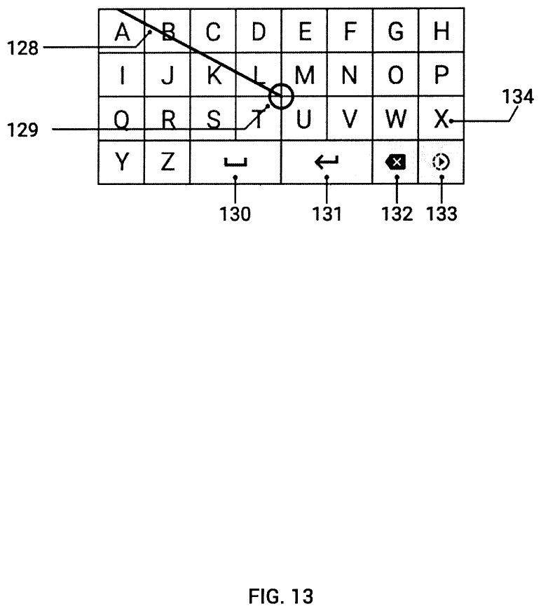

FIG. 13 is an illustrative schematic diagram of Interactive Zone 5 in a Radar Operational Mode (127) with thirty interactive areas including an innovative neurologically-responsive control system comprised of twenty-six interactive alphabetically-arranged letter-based cells (134), one spacebar key writing-control cell (130), one return key writing-control cell (131), one backspace key writing-control cell (132), one input method switching-control cell (133) and an independent clockwise-rotating radar-like interactive graphic line element (128) and an interactive graphic circle element able to slide, stop sliding or continue sliding within the directional path of the interactive graphic line (129). Although depicted with 30 interactive areas, it will be appreciated that other embodiments may include more or less than 30 interactive areas.

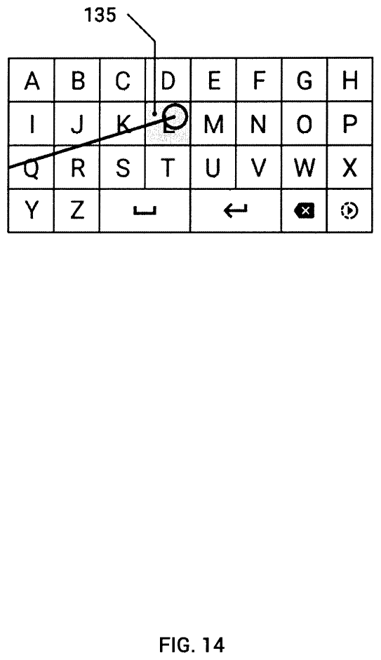

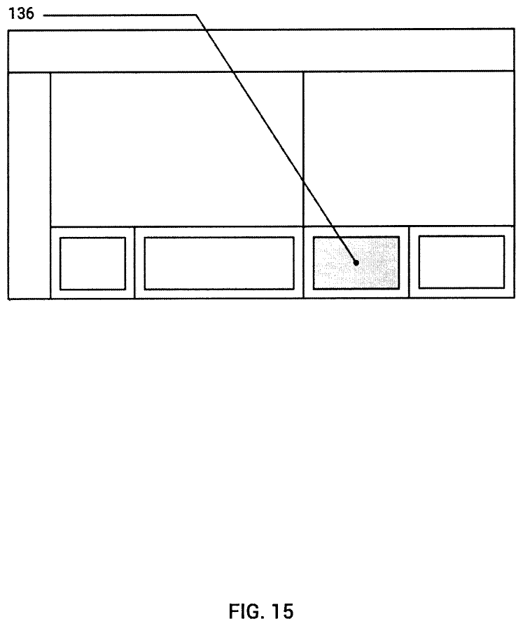

FIG. 14 is an illustrative schematic diagram of Interactive Zone 5 in a Radar Operational Mode (127) with the independent interactive graphic circle element (129) fully slid along the interactive graphic line element (128) and able to activate via human brain-based neurological signals one interactive cell (in this case the letter L key writing-control cell) (135) out of the thirty interactive cells in Interactive Zone 5 (127).

FIG. 15 is an illustrative schematic diagram of the computer operating system's graphical user interface highlighting an area referred to as Interactive Zone 6 in a Standard Operational Mode (136).

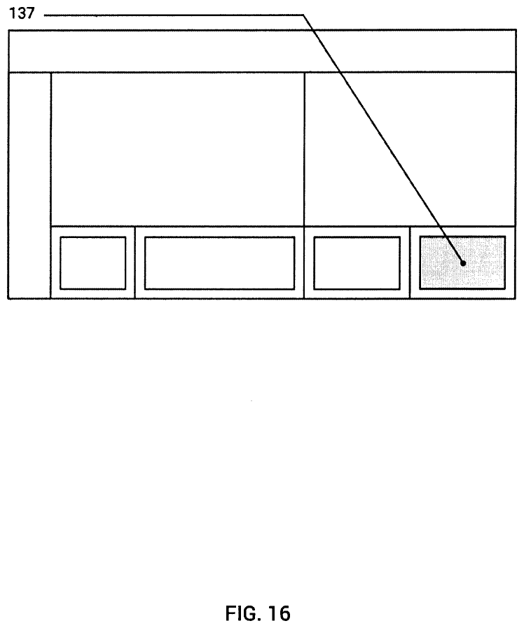

FIG. 16 is an illustrative schematic diagram of the computer operating system's graphical user interface highlighting an area referred to as Interactive Zone 7 in a Standard Operational Mode (137).

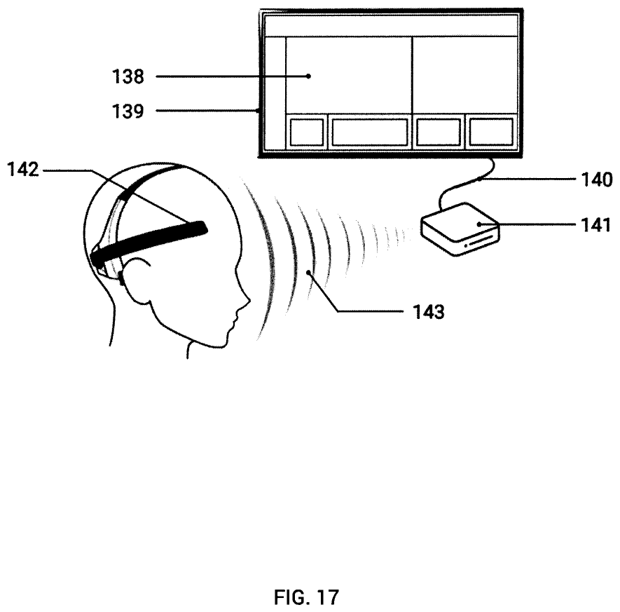

FIG. 17 is an illustrative diagram of an example implementation of a computing device 141 running a computer operating system (138) and displayed in a computer monitor or television (139) via a wired video cable connection (140) to a conventional desktop personal computer device (141). As depicted, the end-user is wearing an electronic device as a wireless headset able to acquire and transmit electroencephalography, electromyography and electrooculography signals from the end-user's human head (142) to the conventional desktop personal computer device (141) via a wireless communication protocol (143) such as the Bluetooth™ wireless technology standard for transmitting data over short distances. It will be appreciated that in some embodiments, wired connections such as video cable connection 140 may instead be wireless, and vice versa.

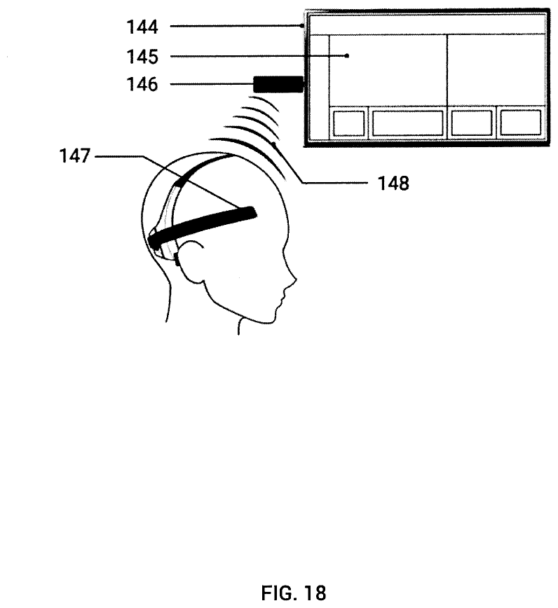

FIG. 18 is an illustrative diagram of another example implementation of the computer operating system (145) displayed in a computer monitor or television (144) with a direct physical Universal Serial Bus (also known as USB) connection to a portable small form factor computing device (such as the Intel Compute Stick) (146). As depicted, the end-user is wearing an electronic device as a wireless headset able to acquire and transmit electroencephalography, electromyography and electrooculography signals from the end-user's human head (147) to the portable small form factor computing device (146) via a wireless communication protocol (148) such as the Bluetooth™ wireless technology standard for transmitting data over short distances.

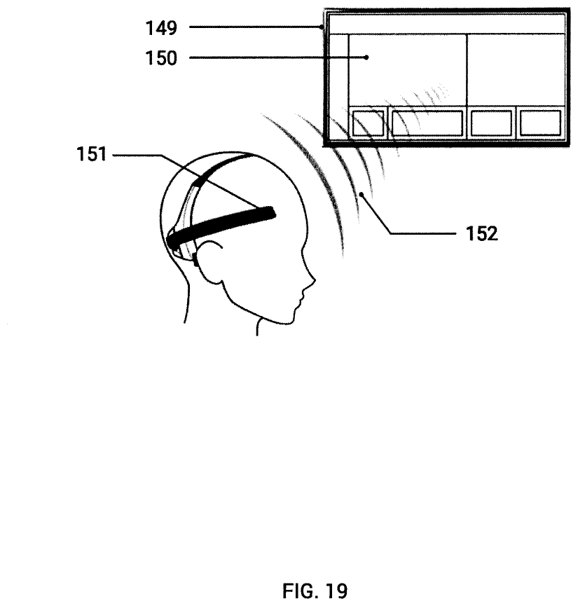

FIG. 19 is an illustrative diagram of another example implementation of the computer operating system (150) displayed in an Internet-ready wirelessly-connected television (also known as a Smart TV appliance) (149). The end-user is wearing an electronic device as a wireless headset able to acquire and transmit electroencephalography, electromyography and electrooculography signals from the end-user's human head (151) to the Internet-ready wirelessly-connected television (149) via a wireless communication protocol (152) such as the Bluetooth™ wireless technology standard for transmitting data over short distances.

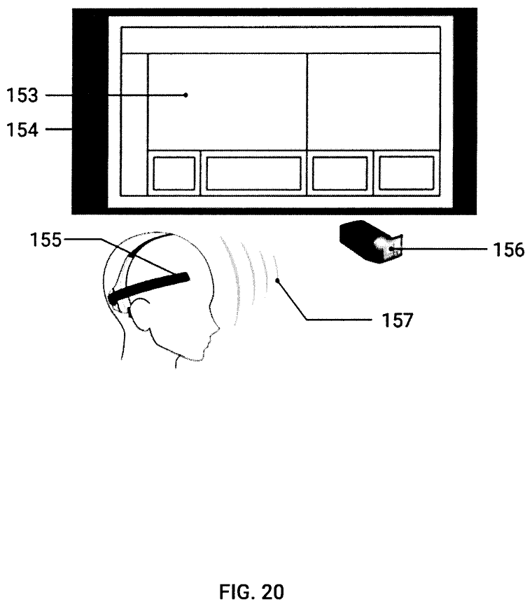

FIG. 20 is an illustrative diagram of another example implementation of the computer operating system (153) displayed on a physical wall or a standard projection screen (154) via an Internet-ready wirelessly-connected projector device (also known as a Smart Projector appliance) (156). As depicted, the end-user is wearing an electronic device as a wireless headset able to acquire and transmit electroencephalography, electromyography and electrooculography signals from the end-user's human head (155) to the Internet-ready wirelessly-connected projector device (156) via a wireless communication protocol (157) such as the Bluetooth™ wireless technology standard for transmitting data over short distances.

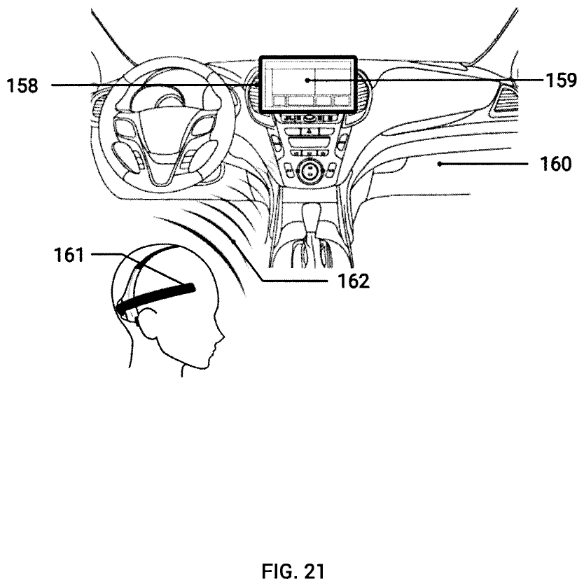

FIG. 21 is an illustrative diagram of another example implementation of the computer operating system (159) displayed on a computing device such as an Internet-ready or communication network-ready wirelessly-connected tablet computer either fully independent and installed as a separate physically-removable electronic appliance in a transportation vehicle (160) (such as a car, truck, bus, train, boat, plane, helicopter, underwater submarine, robotic driverless vehicle, space-enabled vehicle) or as a physically-fixed appliance attached to the transportation vehicle (160) (such as a car, truck, bus, train, boat, plane, helicopter, underwater submarine, robotic driverless vehicle, space-enabled vehicle) and connected to the transportation vehicle's own wired or wireless data management, communication and computing systems (158). The end-user is wearing an electronic device as a wireless headset able to acquire and transmit electroencephalography, electromyography and electrooculography signals from the end-user's human head (161) to the tablet computer (158) via a wireless communication protocol (162) such as the Bluetooth™ wireless technology standard for transmitting data over short distances.

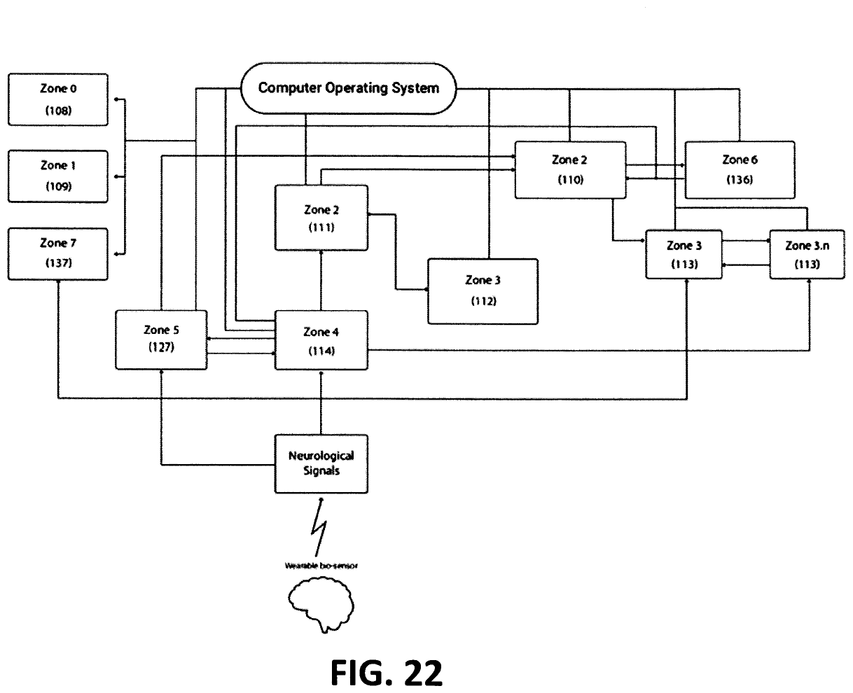

FIG. 22 is an illustrative flowchart of the internal components of an example computer operating system and the interactivity between each of these components.

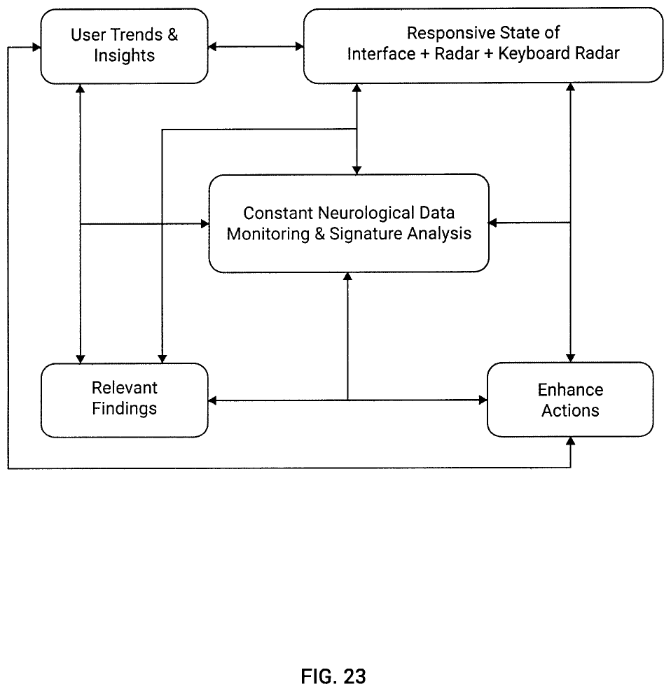

FIG. 23 is an illustrative flowchart of the multi-dimensional and bidirectional relationship between the constant or near-constant monitoring of neurological data by the computer operating system executing on computing device 141 and the responsive state of the computer operating system based on the analysis of the neurological data transmitted to the computer operating system and the various trends, insights and actions generated by the interactions and activations of commands within the computer operating system.

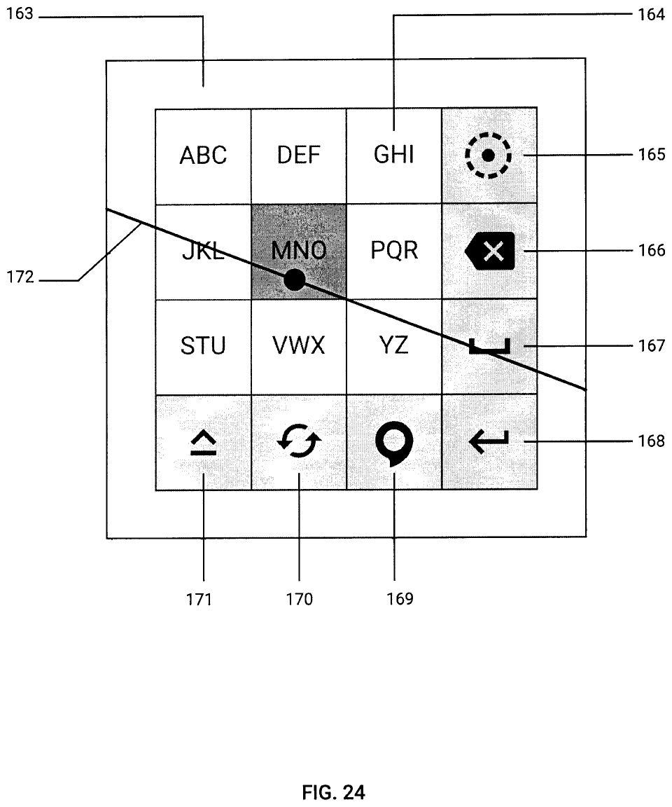

FIG. 24 is a schematic diagram of an example of a responsive state interface upgrade for the radar-like virtual keyboard allowing enhanced and faster letter-based and/or other nested subroutine commands based on the previous accuracy of interactions and activations of commands in a slower less advanced radar-like virtual keyboard in the computer operating system.

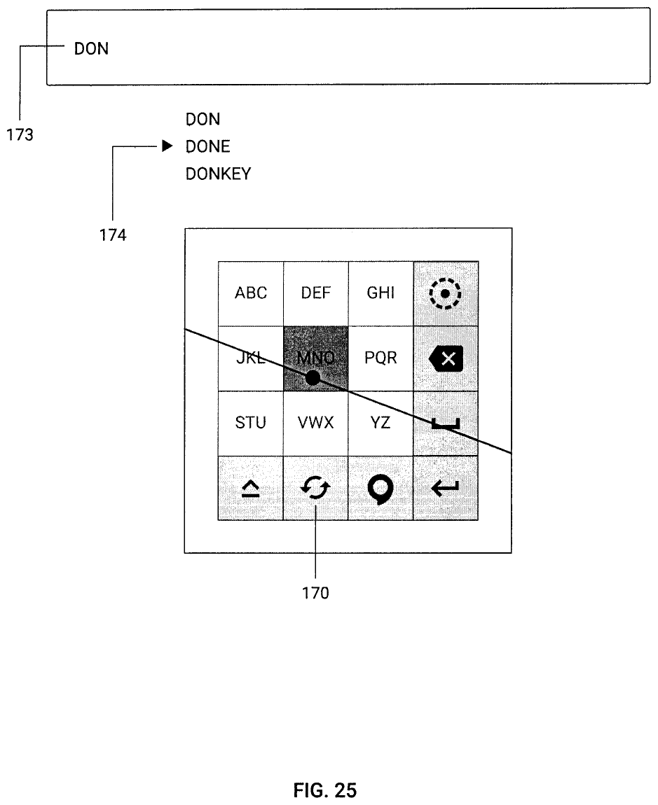

FIG. 25 is a schematic diagram of an example of a responsive state interface upgrade for the radar-like virtual keyboard whereas an enhanced and faster radar-like virtual keyboard is further upgraded with the addition of a word prediction dictionary-based module allowing even faster access, selection and entries of words from the radar-like virtual keyboard into an Interactive Zone in the computer operating system.

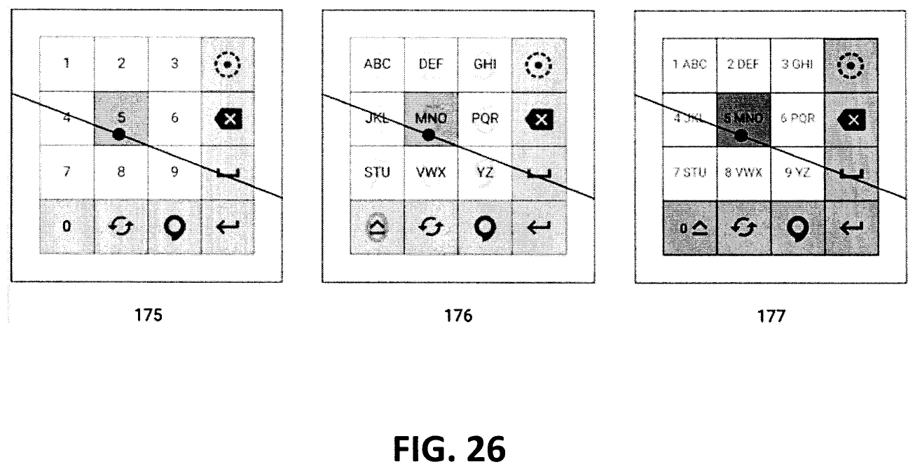

FIG. 26 is a schematic diagram of three examples of responsive state interface upgrades for facilitated alpha-numerical entries by the radar-like virtual keyboard into an Interactive Zone in the computer operating system.

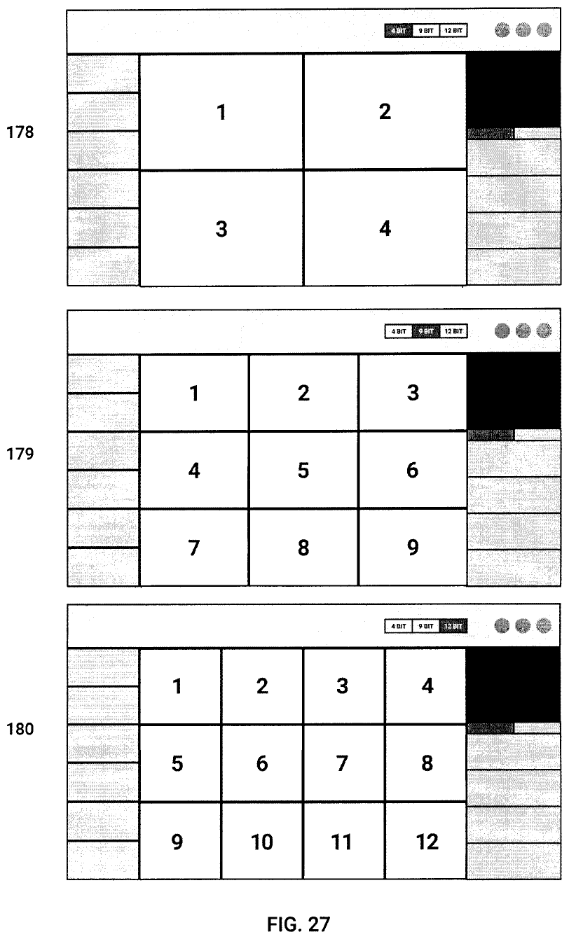

FIG. 27 is a schematic diagram of three examples of responsive state interface upgrades whereas an Interactive Zone in the computer operating system changes its architecture and the related number of features or accessible content based on the analysis of the neurological data transmitted to the computer operating system and the various trends, insights and actions generated by the interactions and activations of commands within the computer operating system.

FIG. 29 is a schematic diagram illustrating a zone in the graphical user interface which implements an improved radar-like indication system. The oscillating radar 172 provides quick access to any four tiles along the line of movement for quick selection. In some embodiments, rather than the radar indicia having to rotate 360 degrees to access tiles on the opposite side, in the embodiment of FIG. 29, the indicia moves along the line and highlights the tiles one by one based on intersections with the tiles. The end user can select the highlighted tile and trigger an action. Some embodiments of this keyboard layout are based on the search algorithms which predict possible words when groups of letters are entered sequentially. For example, the selection of “GHI”, “MNO” and “MNO” may predict the words “Good” or “Gone”. Furthermore, the user can cycle through the predicted words list using a cycle key 170 until the desired word is found. Once found, the end user can use the select key 171 to select that word. Such words may be used as commands to activate artificial intelligence/Internet of Things commands using AI/IOT key 169. For example, commands can trigger, e.g. Alexa, to play music, dim the lights, control the room temperature, or the like. The keyboard layout and oscillating radar indicia of FIG. 29 may reduce the time and distance travelled by the radar indicia by a factor of 2, which improves efficiency of operation. In some embodiments, the user can park the cursor in a safe zone in order to avoid any unintentional selection of a tile while waiting for the radar indicia to continue moving.

Furthermore, the neural operating system executing on computing device 141 may be a computer operating system considered by a person of skill in the art as any of a modified locally-based computer operating system complementary to an already-installed commercially-available locally-based computer operating system on an electronic device, or a modified Internet-based computer operating system complementary to an already-installed commercially-available locally-based computer operating system on an electronic device or a modified Internet web browser-based locally-based computer operating system complementary to an already-installed commercially-available locally-based computer operating system on an electronic device or a standalone computer operating system embedded in an Application-Specific Integrated Circuit Microchip, or a standalone computer operating system as long as an electronic device has the technical capability to initiate a wireless connection to the Internet and supports a personal wireless network and/or short distance wireless data communication protocol such as the Bluetooth™ wireless technology standard for data connectivity between a wireless headset capable of capturing and transmitting live electroencephalography, electromyography and electrooculography signals from the end-user's human head to a computer.

As depicted, Interactive Zone 0 is by default in a computing state referred to as Standard Operational Mode (108), Interactive Zone 1 is by default in a computing state referred to as Standard Operational Mode (109), Interactive Zone 2 is by default in a computing state referred to as Machine Learning in Standard Operational Mode (110), Interactive Zone 3 is by default in a computing state referred to as Machine Learning in Standard Operational Mode (112), Interactive Zone 4 is by default in a computing state referred to as Radar Operational Mode (114), Interactive Zone 5 is by default in a computing state referred to as Radar Operational Mode (127), Interactive Zone 6 is by default in a computing state referred to as Standard Operational Mode (136) and Interactive Zone 7 is by default in a computing state referred to as Standard Operational Mode (137).

A method of navigating across and/or from one of these Interactive Zones into one or several other Interactive Zones may be implemented via the use of neurologically activated navigational controls located in Interactive Zone 4 (114) and in Interactive Zone 5 (127).

As depicted in FIGS. 9, 10 and 11, in Interactive Zone 4 (114), a system of navigational controls is assembling twenty pre-programmed interactive executable cells in a grid-like two-dimensional format of five interactive executable cells adjacent to one another horizontally by four rows of such cells. Although 20 cells are depicted, it will be appreciated that other embodiments may include more or less than 20 cells.

As depicted, these twenty pre-programmed interactive executable cells are logically split by a method of assembling twelve of these interactive executable cells in a sub-grid two-dimensional format of four interactive executable cells adjacent to one another horizontally by three rows of such cells.

This first organization of interactive executable cells in a grid-like format is referred to as Grid-Control Cells (125).

As depicted, the remaining eight interactive executable cells are placed to the top and right of the Grid-Control Cells and are referred to as the Home Button Navigational Control (115), the Back Button Navigational Control (116), the Exit Button Navigational Control (117), the Application Switch Button Navigational Control (118), the Full Screen Display Button Navigational Control (119), the Scroll Up Navigational Control (120), the Scroll Down Button Navigational Control (121) and the Keyboard Radar Activation Button Navigational Control (122).

The Grid-Control Cells (125) may define a system which allows an instantaneous or near-instantaneous execution, activation and change of operational state across one or several of the following Interactive Zones: Interactive Zone 2, Interactive Zone 3, Interactive Zone 5, Interactive Zone 6 and/or Interactive Zone 7.

Furthermore the Grid-Control Cells (125) may be pre-programmed to logically control a secondary operational state in Interactive Zone 2 (102) and Interactive Zone 3 (103) referred to as Machine Learning Zone 2 in Grid Mode (111) and Machine Learning Zone 3 in Grid Mode (113) respectively.

When Interactive Zones 2 and 3 enter this secondary operational state, a method of visualizing, interfacing and controlling local or Internet-based remotely-accessible static and/or dynamically-generated algorithmic content may be initiated via a new executable set of interactive cells located in either Interactive Zone 2 or Interactive Zone 3 in a sub-grid two-dimensional format of four interactive executable cells adjacent to one another horizontally by three rows of such cells matching the interfacing and control methodology applied in the Grid-Control Cells (125) in Interactive Zone 4 (114).

Another system in Interactive Zone 4 consists of an Interactive Graphic Line Element (123) and an Interactive Graphic Circle Element (124) which are programmed to operate in dependence of one another and which are graphically superimposed within the area boundaries of the grid formed by the twenty interactive executable cells in Interactive Zone 4 (114). One end of the Interactive Graphic Line Element (123) is freely attached to the Interactive Graphic Circle Element (124) and the other end of the Interactive Graphic Line Element (123) is programmed to translate along the area boundaries of the grid formed by the twenty interactive executable cells in Interactive Zone 4 (114) in a clockwise rotational fashion, similar to an electronic radar display system scanning a defined geographical area in maritime or avionic navigation systems in industrial or military settings.

An example method for activating Interactive Zone 4 (114) and the execution of a pre-programmed interactive cell (126) in Interactive Zone 4 (114) may be initiated in three steps. Upon the launch of the computer operating system, the Interactive Graphic Line Element (123) starts rotating clockwise while the Interactive Graphic Circle Element (124) remains centered to the grid formed by the twenty interactive executable cells in Interactive Zone 4 (114). The end-user is now able to trigger the activation of the Interactive Graphic Circle Element (124) by a calibration-less and/or training-less analysis of the end-user's neurological signals first stopping the Interactive Graphic Line Element (123) from rotating and allowing the Interactive Graphic Circle Element (124) to start moving along the physical line and towards the border of the grid formed by the twenty interactive executable cells in Interactive Zone 4 (114). Once the end-user estimates that the Interactive Graphic Circle Element (124) has reached a superimposed grid position satisfactory for grid-based control and interactive cell execution, a second neurological trigger can be initiated to stop the Interactive Graphic Circle Element (124) from moving and re-activate immediately the clockwise rotation of the Interactive Graphic Line Element (123). At that time, a third neurological trigger can be activated and the nearest-to-the-Interactive Graphic Circle Element (123) preprogrammed interactive Grid-Control Cell (125) or Navigational Control Cell (115) (116) (117) (118) (119) (120) (121) (122) may then be activated with a nested code subroutine executed instantly (126).

Depending on which interactive cell is activated in the computer operating system via the radar-like visualization and interfacing system, Interactive Zone 2 (110) or (111), Interactive Zone 3 (112) or (113), Interactive Zone 5 (127), Interactive Zone 6 (136) and/or Interactive Zone 7 (137) may initiate their own nested code subroutine associated with either the matching Grid-associated position of the interactive cell in Interactive Zone 2 (111) or Interactive Zone 3 (113) or code subroutine associated with specific features needed for the operation and control of any of the seven other Interactive Zones associated with the execution of the interactive cell from Interactive Zone 4 (114).

Depending on the control, navigation and execution desired by the end-user, the option of initiating a secondary radar-like navigational system as depicted in FIGS. 13 and 14) in Interactive Zone 5 (127) is allowable and facilitated via the activation of the interactive Navigational Control Cell referred to as Keyboard Radar Activation Button (122). Upon execution, the Interactive Zone 4 (114) transfers its neurological signals analytical capability to Interactive Zone 5 (127) and a similarly-controlled superimposed radar-like virtual keyboard (128) (129) (130) (131) (132) (133) is made available to the end-user for various interactive executions of letter-based and/or other nested subroutine commands and instantaneous inputting, deletion, editing and control of character-based communications in associated instant messaging or communication platform module(s) activatable in or from Interactive Zone 2 (110) (111) or from Interactive Zone 3 (112) (113).

All interactions and activations of commands in any of the radar-like navigational system or radar-like virtual keyboard are subject to data logging and analysis over time by the computer operating system for determining the accuracy of each generated command within each of the Interactive Zones, the uniqueness of such generated command over a specific period of time and any potential subsequent impact on any neurological signal being transmitted to the computer operating system.

When a lack of accuracy in interactions and activations of commands is found to be present, the computer operating system can provide a downgradable option to allow a more simplified version of the radar-like navigational system or the radar-like virtual keyboard or a reduction in the number of Interactive Zones for usage.

Alternatively, if the accuracy in interactions and activations of commands is found to be improving over time, the computer operating system can provide an upgradable option for a more complex or more accelerated radar-like navigational system, radar-like virtual keyboard or an increase in the number of Interactive Zones for usage.

Furthermore, if the interactions or activations of commands are found to be impacting the live neurological signals transmitted to the computer operating system, the computer operating system can further monitor, classify and categorize either locally or in a remote system such as a distributed computer network or a cloud-based computing environment the neurological activity in question.

Due to the constant or ongoing neurological data transmitted into the computer operating system, the computer operating system may be capable internally or externally via a remote system such as a distributed computer network or a cloud-based computing environment to further determine over time specific trends or insights via various black box machine learning methodologies such as filtering of the neurological data via artificial neural networks or specific mathematical or waveform algorithmic analysis or specific signature extraction.

As depicted in FIGS. 23, 24, 25, 26, 27, such ongoing monitoring of the neurological data transmitted into the computer operating system and the subsequent determination of trends and insights in the neurological data transmitted into the computer operating system due to previous interactions or activations or newly-enhanced and optimized interactions or activations in the computer operating system allows the computer operating system to provide natively an adaptive and responsive architecture for enhancing, guiding, classifying, formatting, presenting, precising, scheduling or prioritizing at an individualistic level some or all interactions and activations of commands over time by automatically upgrading the components of each Interactive Zone of the computer operating system based on the constantly-analyzed relevant findings from the usage in the responsive architecture of the computer operating system and the subsequent multi-dimensional and bidirectional impact over time generated into the neurological data by each enhanced action, interaction or activation in each of the Interactive Zones of the computer operating system.

By providing a responsive state interfacing upgradability based on the neurological data transmitted to the computer operating system, the computer operating system is natively capable of providing a newly responsive state to modify or prioritize certain functions internally as well as in external compatible computing modules, applications or systems able to communicate electronically with the computer operating system. For example, if the computer operating system determines that the accuracy of typing a custom message via the radar-like virtual keyboard has reached a set level of high accuracy, the computer operating system can allow such custom message to be transmitted to an external computing module for short message services or automatic interaction via synthesized speech with external artificial intelligence personal assistants such as Amazon Alexa or Google Assistant.

As depicted in FIG. 1, the computer operating system natively organizes, manages and displays all relevant functionality, features, local or remotely-accessible static or dynamically-generated algorithmic content in various Interactive Zones in a GUI, each of them carrying a separate set of preprogrammed instructions and/or neurologically-based control methods. Furthermore, the system architecture allows for the content generation, activation, execution, navigation and internal management of an unlimited integration of internal or third-party software applications or application programming interfaces. As such, there is provided a method of presenting any information, content, data and/or feature relevant to the end-user or dynamically-generated by the end user based on one or any of the following parameters:
(i) the end-user's demographic data
(ii) the end-user-based pattern recognitions of the computer operating system navigation
(iii) the end-user-based pattern recognitions of the computer operating system usage trends
(iv) the frequency and repetition levels of identical or similarly-accessed content by the end-user
(v) the prioritization of content based on the end-user's physical health at the time of interaction between the end-user and the computer operating system
(vi) the prioritization of content based on the end-user's mental health at the time of interaction between the end-user and the computer operating system
(vii) the prioritization of content based on the end-user's intellectual health at the time of interaction between the end-user and the computer operating system
(viii) the status of independent physiological functioning or physiological functioning via assisted caregiving receivership or under medical supervision
(ix) the end-user professional qualifications
(x) the end-user professional activity
(xi) the end-user professional activity at the time of interaction between the end-user and the computer operating system
(xii) the time of day, week, month and year
(xiii) the end-user temperature
(xiv) the environmental temperature surrounding the end-user
(xv) the physical geographic location of the end-user

The method is simplified, streamlined, optimized and directly presents to the end-user an innovative interfacing to the relevant functionality or content. Such method is in stark contrast to the more classical approach of Human to Computer interactions, wherein an end-user must go through multiple phases of activation, searching, selection and eventually gains access to a certain functionality or content. In some embodiments, the present systems and methods provide a computer operating system and its managed interfacing, the computer operating system provides both an immediate display of functionality and an improved content management and content generation system based on machine learning for one or more particular end-users.

The machine learning methodology for the computer operating system assimilates over time the previously-listed parameters upon each usage of the computer operating system by the end-user and defines, organizes, replaces, downloads, loads, presents and visualizes in the various grid-organized executable interactive cells in either Interactive Zone 2 (111) or Interactive Zone 3 (113) the most relevant functionality and content for that end-user.

For an individual skilled in the art, various implementation scenarios can be considered for the computer operating system both in terms of physical and technical deployments, as depicted in FIGS. 17, 18, 19, 20 and 21, the same being true in terms of various implementation scenarios for machine learning integration.

FIG. 28 is a block diagram depicting components of an example computing device 141. Computing device 141 may be any suitable computing device, such as a server, a desktop computer, a laptop computer, a tablet, a smartphone, and the like. Computing device 141 includes one or more processors 2801 that control the overall operation of computing device 141. The processor 2801 interacts with several components, including memory 2804 via a memory bus 2803, and interacts with accelerator 2802, storage 2806, and network interface 2810 via a bus 2809. Optionally, the processor 2801 interacts with I/O devices 2808 via bus 2809. Bus 2809 may be one or more of any type of several buses, including a peripheral bus, a video bus, and the like.

Each processor 2801 may be any suitable type of processor, such as a central processing unit (CPU) implementing for example an ARM or x86 instruction set, and may further include specialized processors such as a Graphics Processing Unit (GPU), Neural processing unit (NPU), AI cores, or any other suitable processing unit. Accelerator 2802 may be, for example, an accelerated processing unit (e.g. a processor and graphics processing unit combined onto a single die or chip). Memory 2804 includes any suitable type of system memory that is readable by processor 2801, such as static random access memory (SRAM), dynamic random access memory (DRAM), synchronous DRAM (SDRAM), read-only memory (ROM), or a combination thereof. In an embodiment, memory 2801 may include more than one type of memory, such as ROM for use at boot-up, and DRAM for program and data storage for use while executing programs. Storage 2806 may comprise any suitable non-transitory storage device configured to store data, programs, and other information and to make the data, programs, and other information accessible via bus 2809. Storage 2806 may comprise, for example, one or more of a solid state drive, a hard disk drive, a magnetic disk drive, an optical disk drive, a secure digital (SD) memory card, and the like.

I/O devices 2808 include, for example, user interface devices such as a display device, including a touch-sensitive display device capable of displaying rendered images as output and receiving input in the form of touches. In some embodiments, I/O devices 2808 additionally or alternatively include one or more of speakers, microphones, cameras, sensors such as accelerometers and global positioning system (GPS) receivers, keypads, or the like. In some embodiments, I/O devices 2808 include ports for connecting computing device 141 to other client devices or to external sensors (e.g. sensors for measuring an end-user's brain activity). In an example embodiment, I/O devices 2808 include a universal serial bus (USB) controller for connection to peripherals or to host computing devices.

Network interface 2810 is capable of connecting computing device 141 to a communication network 2814. In some embodiments, network interface 2810 includes one or more of wired interfaces (e.g. wired Ethernet) and wireless radios, such as WiFi, Bluetooth, or cellular (e.g. GPRS, GSM, EDGE, CDMA, LTE, or the like). Network interface 2810 enables computing device 141 to communicate with other computing devices, such as a server, via the communications network 2814. Network interface 2810 can also be used to establish virtual network interfaces, such as a Virtual Private Network (VPN).

Computing device 141 may implement an operating system as described herein which presents the above-noted graphical user interface and associated functionality to the end user. Each module in the operating system may include computer-readable instructions which are executable by the processor 2801 (and optionally accelerator 2802) of computing device 141. The computer-readable instructions of the modules of the operating system are executed by the processor 2801 of the computing device 141. In other embodiments, computer-readable instructions of one or more modules of the operating system may be executed by one or more computing devices remote from computing device 141 (e.g. back-end or cloud computing systems which similarly including processing devices and storage media).

As an implementation example of the computer operating system using machine learning to adapt its functionality and the content to be accessed by the end-user, a physically-disabled hands-amputated eight-year-old boy may use the neural operating system differently than a thirty-five-year-old injured army veteran with post-traumatic stress disorder and still differently than an octogenarian grandmother needing to interact with her children, grandchildren, daily caregiver and doctors yet unable to use her hands to type due to severe arthritis or subject to a lack of knowledge on how to use a traditional computer and standard computer operating system.

Machine Learning Zone 2 (110) (111) and Machine Learning Zone 3 (112) (113) allows a Computer to Human Interaction and Computer to Human Interfacing which is intelligent, modifiable, adaptive to each end-user while providing innovative neurologically-based interactive navigational controls and novel communication controls which do not rely on the standard and slower P300 event-related potential methodology, thus bypassing the existing operational limitations of other currently-available computer operating systems.

In another embodiment of the invention, the computer operating system initializes with Machine Learning Zone 2 in a Grid Mode (111) and Machine Learning Zone 3 in a Standard Operational Mode (112) with all other Interactive Zones loaded. The Machine Learning Zone 2 in a Grid Mode (111) presents to the end-user a choice of twelve grid-formatted interactive cells allowing the immediate access to end-user-relevant static and/or machine learning-based algorithmically-organized content accessible via twelve categorized launchpad-like interactive cells. The end-user can then choose one of the twelve interactive cells via the neurologically-responsive and already activated Interactive Zone 4 which offers by default the same two-dimensional grid-like format for Grid-Control Cells (125). Upon selection of a Grid-Control Cell (126), Machine Learning Zone 2 in a Grid Mode (111) changes state to Machine Learning Zone 2 in a Standard Operational Mode (110) and loads automatically the default most predicted and/or preferred content in that zone's new state and Machine Learning Zone 3 in a Standard Operational Mode (112) changes state to Machine Learning Zone 3 in a Grid Mode (113) and updates itself automatically with all other options available up to an unlimited local or remotely-accessible static or dynamically-generated algorithmic content sorted in a grid-like twelve interactive cell format and as per one or any combination of the parameters listed herein above for machine learning-based interfacing of the computer operating system per end-user.

Furthermore, a method to switch between content belonging in the same initialized category now listed in Machine Learning Zone 3 in a Grid Mode (113) is available via Interactive Zone 4 and the execution of any Grid-Control Cell (126).

Alternatively, a method to switch between main category of content from the initial Machine Learning Zone 2 in a Grid Mode is allowed by the execution of Navigational Control—Home Button (115) resetting the interfacing to its initialization default.

Alternatively, a method to transfer the content now appearing in Machine Learning Zone 2 in a Standard Operational Mode can be achieved by the multi-tasking capability and execution of navigational Control—Application Switch Button (118) thus allowing the original content in Machine Learning Zone 2 in a Standard operational Mode (110) to now appear in a smaller format in Interactive Zone 6 and instantly providing further selection capability to be launched from Machine Learning Zone 3 in a Grid Mode (113) into Machine Learning Zone 2 in a Standard Operational Mode (110).

Alternatively, a method to expand the interface of Machine Learning Zone 2 in a Standard Operational Mode (110) to an exit-capable full screen mode overlaying in full opacity all other Interactive Zones is allowed by the execution and subsequently reversible execution if desired of Navigational Control—Full Screen Display Button (119).

Alternatively, a method to scroll up or down larger content being presented in Machine Learning Zone 2 in a Standard Operational Mode (110) can be initialized via the execution of Navigational Control—Scroll Up Button (120) or Navigational Scroll Down Button (121).

Alternatively, a method to return to previously-listed content options in Machine Learning Zone 3 in a Grid Mode (113) is available if an end-user wishes has accessed any content executable beyond any of the first twelve interactive launchpad-like cells in Machine Learning Zone 3 in a Grid Mode (113), such method to return to previously-accessible content options being initialized via the execution of Navigational Control—Back Button (116).

In another aspect of the innovation, Machine Learning Zone 3 (112) (113) presents local or remotely-accessible static or dynamically-generated algorithmic content based on the default or the initiated executed selection of content in Machine Learning Zone 2 (110) (111) via Grid-Control Cells in Interactive Zone 4 (125).

Furthermore, Machine Learning Zone 3 in a Grid Mode (113) loads by default a twelfth grid-based interactive cell referred to as “MORE”. The end-user can navigationally control and launch this twelfth grid-based interactive cell in Machine Learning Zone 3 in a Grid Mode (113) via the execution of the matching two-dimensionally-placed Grid-Control Cell (126) in Interactive Zone 4 (114) allowing the instant availability of more relevant and/or machine learning-prioritized content to be loaded in a new set of 11 interactive cells in Machine Learning Zone 3 in a Grid Mode, the twelfth grid-based interactive cell remaining as “MORE” in that new sequence to further load an unlimited number of new set of interactive cells if relevant and available or selected and displayed by machine learning. This method allows the end-user to explore and access pre-determined and/or intelligently-organized unlimited content as per the end-user's parameters of machine learning analysis as hereinabove listed.

In another aspect of the innovation, the Interactive Zone 0 (108) accesses automatically external data sources such as via weather information's and IP geo-location services' application programming interfaces to geo-localize and inform the end-user upon the computer operating system initialization as well as display various connectivity icons, battery status and other preferred assistive metrics relevant to external components such as wirelessly-connected electronic devices.

In another aspect of the innovation, the Interactive Zone 1 (109) is a dynamically-generated bio-feedback monitoring real-time control center. It is designed to show the neurological signals of the end-user continuously for both the end-user or any caregiver or assistant.

The Interactive Zone 1 displays the end-user's level of cognitive focus, level of meditation, the level of mental effort, the type of emotion (positive or negative) and the level of appreciation which can be used to interpret the end-user's mental health.

In another aspect of the innovation, the Interactive Zone 6 is designed as a method to help an end-user perform via neurological commands multi-tasking operations within the computer operating system. The end-user is allowed to hold one content at a time in Interactive Zone 6 so it does not create a cognitive overload on the end-user. As an implementation example, the end-user can minimize into Interactive Zone 6 any video content or music-based content originally loaded in Machine Learning Zone 2 in a Standard Operational Mode (110) and start interacting with a friend via the execution of a grid-based interactive cell for instant messaging to be loaded in Machine Learning Zone 2 in a Standard Operational Mode (110).

In another aspect of the innovation, the Interactive Zone 7 allows the integration, initialization and execution of a live remote monitoring of the computer operating system by a third-party via an IP connection or a live video conferencing session between the end-user and a remotely-located third-party via an IP connection. An example of such implementation can be a medical doctor checking on a physically-disabled patient released from a specialized ward for home-based rehabilitation.

Numerous variations and embodiments are contemplated, including:
(1) A method to use human brain-based neurological signals to interact with a computer operating system without any preliminary or ongoing hardware calibration or training.
(2) A method to use human brain-based neurological signals to interact with a computer operating system without any preliminary or ongoing software calibration or training.
(3) A method to use human brain-based neurological signals to control a computer operating system or modified computer operating system.
(4) A method to use human brain-based neurological signals to navigate through the features of a computer operating system.
(5) A method to use human brain-based neurological signals only to view, change or update the content of a computer operating system's graphical user interface.
(6) A computer operating system configured to support the encryption, decryption and computer-compatible interpretation of neurological data received from a human brain;
(7) A method to process, filter and classify neural commands from a human brain into active computer commands for the neurologically-based functioning of a computer operating system.
(8) An interactive graphical user interface system designed for streamlined interactions between an end-user and a computer operating system architected for and responsive to human brain-based navigational commands.
(9) An interactive graphical user interface system customized for each independent end-user based on the end-user neurological and cognitive capabilities over time.
(10) A method as described above, whereby an end-user is capable of using human brain-based neurological signals to download external computer data into a computer operating system, a computer hardware or a computer software application.
(11) A method as described above, whereby an end-user is capable of using human brain-based neurological signals to download or digitally stream and subsequently play a music data file into a computer operating system, a computer hardware or a computer software application.
(12) A method as described above, whereby an end-user is capable of using human brain-based neurological signals to download or digitally stream and subsequently play a video data file into a computer operating system, a computer hardware or a computer software application.
(13) A method as described above, whereby an end-user is capable of using human brain-based neurological signals to store and retrieve a data file into a computer.
(14) A method as described above, whereby an end-user is capable of using human brain-based neurological signals to broadcast and communicate via the use of a computer operating system the human being's own state of physical health to either another independent human being or another computer operating system or computer hardware or computer software application.
(15) A method as described above, whereby an end-user being is capable of using human brain-based neurological signals to broadcast and communicate via the use of a computer operating system the human being's own state of mental health to either another independent human being or another computer operating system or computer hardware or computer software application.
(16) A method as described above, whereby an end-user is capable of using human brain-based neurological signals to broadcast and communicate via the use of a computer operating system the human being's own state of cognitive alertness to either another independent human being or another computer operating system or computer hardware or computer software application.
(17) A method as described above, whereby an end-user is capable of using human brain-based neurological signals to broadcast and communicate via the use of a computer operating system the human being's own state of mental stress to either another independent human being or another computer operating system or computer hardware or computer software application.
(18) A method as described above, whereby an end-user is capable of using human brain-based neurological signals to broadcast and communicate via the use of a computer operating system the human being's own state of fear to either another independent human being or another computer operating system or computer hardware or computer software application.
(19) A method as described above, whereby an end-user is capable of using human brain-based neurological signals to broadcast and communicate via the use of a computer operating system the human being's physiological description of a sudden injury or a set of sudden injuries to either another independent human being or another computer operating system or computer hardware or computer software application.
(20) A method as described above, whereby an end-user is capable of using human brain-based neurological signals via the use of a computer operating system to alert another human being or another computer operating system of an algorithmically-predicted variable state of potential to immediate life-threatening danger.
(21) A method as described above, whereby an end-user is capable of using human brain-based neurological signals via the use of a computer operating system to communicate with another human being by utilizing a neurologically-controlled embedded live video-conferencing software application.
(22) A method as described above, whereby an end-user is capable of using human brain-based neurological signals via the use of a computer operating system to communicate with another human being by utilizing embedded pre-recorded audio-visual messages.
(23) A method as described above, whereby an end-user is capable of using human brain-based neurological signals to control and operate a computer operating system by locating pre-programmed computer code and targeting and launching the technical execution of such code via the use of an embedded neurologically-controlled digital radar computer code-locating interface.
(24) A method as described above, whereby an end-user is capable of using human brain-based neurological signals via the use of a computer operating system to communicate with another human being by utilizing a virtual keyboard to type a text message with a non-assisted, non-archived, non-predictive, non-P300 Event-Related Potential Brain-to-Computer Interface system for slower conventional character spelling method, such virtual keyboard being itself neurologically-controlled by an embedded digital radar letter-locating interface.
(25) A method as described above, whereby an end-user is capable of using human brain-based neurological signals via the use of a computer operating system to communicate with another human being by utilizing a virtual keyboard to type a digitally-assisted predictive text-based message with a non-P300 conventional Brain-to-Computer Interface system for character spelling method, such keyboard being itself neurologically-controlled by an embedded digital radar letter-locating and word-locating interface.
(26) A method as described above, whereby a computer operating system controlled by human brain-based neurological signals locates, selects, prioritizes, schedules, organizes, stores and displays independently in the computer user interface via machine-learning algorithms external content in a digital form to an end-user based on the end-user demographic data.
(27) A method as described above, whereby a computer operating system controlled by human brain-based neurological signals locates, selects, prioritizes, schedules, organizes, stores and displays independently in the computer user interface via machine-learning algorithms external content in a digital form to an end-user based on the pattern recognitions of the computer operating system navigation by the end-user.
(28) A method as described above, whereby a computer operating system controlled by human brain-based neurological signals locates, selects, prioritizes, schedules, organizes, stores and displays independently in the computer user interface via machine-learning algorithms external content in a digital form to an end-user based on the pattern recognitions of the computer operating system usage trends by the end-user.
(29) A method as described above, whereby a computer operating system controlled by human brain-based neurological signals locates, selects, prioritizes, schedules, organizes, stores and displays independently in the computer user interface via machine-learning algorithms external content in a digital form to an end-user based on the frequency and repetition levels of historically-identical or similarly-accessed content by the end-user.
(30) A method as described above, whereby a computer operating system controlled by human brain-based neurological signals locates, selects, prioritizes, schedules, organizes, stores and displays independently in the computer user interface via machine-learning algorithms external content in a digital form to an end-user based on the physical health of the end-user at the time of interaction between the end-user and the computer operating system.
(31) A method as described above, whereby a computer operating system controlled by human brain-based neurological signals locates, selects, prioritizes, schedules, organizes, stores and displays independently in the computer user interface via machine-learning algorithms external content in a digital form to an end-user based on the mental health of the end-user at the time of interaction between the end-user and the computer operating system.
(32) A method as described above, whereby a computer operating system controlled by human brain-based neurological signals is able to download and install external neurologically-controlled third-party-developed software applications or third-party-developed gaming applications within the computer operating system user interface based on the end-user preferences and end-user demographic data.
(33) A method as described above, whereby a computer operating system controlled by human brain-based neurological signals downloads, organizes, categorizes and presents in its user interface an unlimited amount of static pre-programmed content or algorithmically-based dynamically-generated content to an end-user.
(34) A method as described above, whereby a computer operating system controlled by human brain-based neurological signals allows an end-user to access, display, select, view, purchase third-party goods or services via the completion of a financial transaction from an online e-commerce platform or an online electronic payment gateway.
(35) A method as described above, whereby a computer operating system controlled by human brain-based neurological signals allows an end-user to communicate with another human being or an animal or a robot via pre-programmed audio-only, visual-only or audio-visual messages displayed in the computer operating system's graphic user interface.
(36) A method as described above, whereby a computer operating system controlled by human brain-based neurological signals allows an end-user to communicate with another human being or an animal or a robot via pre-programmed audio-only, visual-only or audio-visual messages displayed in a remotely-located Internet web-browser or web-capable mobile software application or delivered via a computer file-transfer or upload/download application or computer-based process or computer-based service to that third-party.
(37) A method as described above, whereby a computer operating system controlled by human brain-based neurological signals allows an end-user to communicate with another human being remotely located to receive technical support or expert professional advice such as legal, financial or medical consultations.
(38) A method as described above, whereby a computer operating system controlled by human brain-based neurological signals allows an end-user to communicate with another human being remotely located to receive immediate emergency medical assistance.
(39) A method as described above, whereby a computer operating system controlled by human brain-based neurological signals allows an end-user to communicate with another human being remotely located to receive immediate emergency medical ambulatory or medically-required transportation assistance.
(40) A method as described above, whereby a computer operating system controlled by human brain-based neurological signals allows an end-user to communicate with another human being remotely located to receive immediate emergency police assistance.
(41) A method as described above, whereby a computer operating system controlled by human brain-based neurological signals allows an end-user to communicate with another human being remotely located to receive immediate emergency firefighting assistance.
(42) A method as described above, whereby a computer operating system controlled by human brain-based neurological signals allows an end-user to login into an online social media messaging platform to interact with the end-user's contacts or any other member of the messaging platform.
(43) A method as described above, whereby a computer operating system controlled by human brain-based neurological signals allows an end-user to login into an online live videoconferencing platform to interact with the end-user's contacts or any other third-party individual.
(44) A method as described above, whereby a computer operating system controlled by human brain-based neurological signals allows an end-user to access, view and listen to daily local and international news' video broadcasts or audio-only broadcasts.
(45) A method as described above, whereby a computer operating system controlled by human brain-based neurological signals allows an end-user to access, view and listen to music video broadcasts or audio-only music broadcasts.
(46) A method as described above, whereby a computer operating system controlled by human brain-based neurological signals allows an end-user to access, view and listen to online pre-recorded cinematographic films, movies and/or television series or any live or pre-recorded television-based broadcast.
(47) A method as described above, whereby a computer operating system controlled by human brain-based neurological signals allows an end-user to access and control locally or remotely Internet-connected home-based automations.
(48) A method as described above, whereby a computer operating system controlled by human brain-based neurological signals allows an end-user to access remotely-located or Internet cloud-based financial records such as personal or commercial banking information and initiate financial transactions by using the computer operating system.
(49) A method as described above, whereby a computer operating system controlled by human brain-based neurological signals allows an end-user to integrate, download, purchase, subscribe, access, view, list, add, delete, search for and execute third-party-developed neurological signals-based software applications or third-party-developed neurological signals-based software gaming applications within the computer operation system.
(50) A method as described above, whereby a computer operating system controlled by human brain-based neurological signals is an Internet web browser-capable internal instruction execution system associated with static or dynamically-generated internal or external logic, data, content or information.
(51) A method as described above, whereby a computer operating system controlled by human brain-based neurological signals has a graphic computer interface controlled by the interactive positioning and the interactive execution of computer code represented by a graphic or set of graphics linearly or radially moving or translating within a graphical grid-like representation of the computer operating system's graphic user interface or parts thereof.
(52) A method as described above, whereby a computer operating system controlled by human brain-based neurological signals has a graphical grid-like representation of the computer operating system's graphic user interface or parts thereof acting as a two-dimensional receptor of a computer code execution.
(53) A method as described above, whereby a computer operating system controlled by human brain-based neurological signals has a two-dimensional receptor of a code execution in the graphical form of a grid whereas each cell of the grid is an independent physical area able to be activated by the original code execution and subsequently generate an automatic secondary subroutine nested code execution, itself capable of launching and executing further subroutine nested code executions either processed locally by the computer operating system or the computer operating system's graphic user interface or processed externally by other third-party independent electronic systems upon receipt.
(54) A method as described above, whereby a computer operating system controlled by human brain-based neurological signals has the ability to discern or prioritize a code execution initiated by an interaction between two or more graphical elements by calculating the mathematical difference and/or the physical distance between each of the geometrical centers of the graphical elements within the computer operating system's graphical user interface.

### NUMERICAL REFERENCES

100. System Architecture—Interactive Zone 0
101. System Architecture—Interactive Zone 1
102. System Architecture—Interactive Zone 2
103. System Architecture—Interactive Zone 3
104. System Architecture—Interactive Zone 4
105. System Architecture—Interactive Zone 5
106. System Architecture—Interactive Zone 6
107. System Architecture—Interactive Zone 7
108. System Architecture—Interactive Zone 0 in a Standard Operational Mode
109. System Architecture—Interactive Zone 1 in a Standard Operational Mode
110. System Architecture—Machine Learning Zone 2 in a Standard Operational Mode
111. System Architecture—Machine Learning Zone 2 in a Grid Mode
112. System Architecture—Machine Learning Zone 3 in a Standard Operational Mode
113. System Architecture—Machine Learning Zone 3 in a Grid Mode
114. System Architecture—Interactive Zone 4 in a Radar Operational Mode
115. Neurologically Activated Navigational Control—Home Button
116. Neurologically Activated Navigational Control—Back Button
117. Neurologically Activated Navigational Control—Exit Button
118. Neurologically Activated Navigational Control—Application Switch Button
119. Neurologically Activated Navigational Control—Full Screen Display Button
120. Neurologically Activated Navigational Control—Scroll Up Button
121. Neurologically Activated Navigational Control—Scroll Down Button
122. Neurologically Activated Navigational Control—Keyboard Radar Activation Button
123. Neurologically Activated Navigational Control—Radar—Interactive Graphic Line Element
124. Neurologically Activated Navigational Control—Radar—Interactive Graphic Circle Element
125. Neurologically Activated Navigational Control—Twelve Grid-Control Cells
126. Neurologically Activated Navigational Control—One Activated Grid-Control Cell
127. System Architecture—Interactive Zone 5 in a Radar Operational Mode
128. Neurologically Activated Navigational Control—Keyboard Radar—Interactive Graphic Line Element
129. Neurologically Activated Navigational Control—Keyboard Radar—Interactive Graphic Circle Element
130. Neurologically Activated Navigational Control—Keyboard Radar—Spacebar Key Writing-Control Cell
131. Neurologically Activated Navigational Control—Keyboard Radar—Return Key Writing-Control Cell
132. Neurologically Activated Navigational Control—Keyboard Radar—Backspace Key Writing-Control Cell
133. Neurologically Activated Navigational Control—Keyboard Radar—Input Method Switching-Control Cell
134. Neurologically Activated Navigational Control—Keyboard Radar—Alphabetical Letter-based Writing-Control Cell
135. Neurologically Activated Navigational Control—Keyboard Radar—Alphabetical Letter-based Activated Writing-Control Cell
136. System Architecture—Interactive Zone 6 in a Standard Operational Mode
137. System Architecture—Interactive Zone 7 in a Standard Operational Mode
138. Implementation—Example #1—Neural Operating System displayed in a computer monitor or television based on an end-user's neurological signals transmitted via a wireless headset to an Internet-ready wirelessly-connected conventional desktop personal computer device
139. Implementation—Example #1—A computer monitor or television
140. Implementation—Example #1—A wired video cable connection
141. Implementation—Example #1—An Internet-ready wirelessly-connected conventional desktop personal computer device
142. Implementation—Example #1—An end-user wearing a wireless headset transmitting neurological signals from the end-user's human head
143. Implementation—Example #1—A wireless communication protocol
144. Implementation—Example #2—A computer monitor or television
145. Implementation—Example #2—Neural Operating System displayed in a computer monitor or television based on an end-user's neurological signals transmitted via a wireless headset to an Internet-ready wirelessly-connected portable small form factor computing device
146. Implementation—Example #2—An Internet-ready wirelessly-connected portable small form factor computing device
147. Implementation—Example #2—An end-user wearing a wireless headset transmitting neurological signals from the end-user's human head
148. Implementation—Example #2—A wireless communication protocol
149. Implementation—Example #3—An Internet-ready wirelessly-connected television
150. Implementation—Example—Neural Operating System displayed in a computer monitor or television based on an end-user's neurological signals transmitted via a wireless headset to an Internet-ready wirelessly-connected television
151. Implementation—Example #3—An end-user wearing a wireless headset transmitting neurological signals from the end-user's human head
152. Implementation—Example #3—A wireless communication protocol
153. Implementation—Example—Neural Operating System displayed in a computer monitor or television based on an end-user's neurological signals transmitted via a wireless headset to an Internet-ready wirelessly-connected projector
154. Implementation—Example #4—A residential wall or office wall or deployed projection screen
155. Implementation—Example #4—An end-user wearing a wireless headset transmitting neurological signals from the end-user's human head
156. Implementation—Example #4—An Internet-ready wirelessly-connected projector
157. Implementation—Example #4—A wireless communication protocol
158. Implementation—Example #5—An Internet-ready wirelessly-connected tablet computer
159. Implementation—Example #5—Neural Operating System displayed in a computer monitor or television based on an end-user's neurological signals transmitted via a wireless headset to an Internet-ready wirelessly-connected tablet computer
160. Implementation—Example #5—A transportation vehicle
161. Implementation—Example #5—An end-user wearing a wireless headset transmitting neurological signals from the end-user's human head
162. Implementation—Example #5—A wireless communication protocol
163. Neurologically Adaptive and Responsive Interfacing—Upgraded Keyboard Radar with Selection by Oscillation based on User Accuracy and Constant Monitoring of Neurological Data with Safe Zone for Easier Control and Pausing of the Upgraded Keyboard Radar
164. Neurologically Adaptive and Responsive Interfacing—Upgraded Keyboard Radar with a Multi-Letter Selection Capability per Interactive Zone
165. Neurologically Adaptive and Responsive Interfacing—Selector Switch for Override of Automatic Upgrade or Downgrade of the Keyboard Radar Interfacing
166. Neurologically Adaptive and Responsive Interfacing—Upgraded Deletion Key with Multi-State Deletion for Letter or Word Deletion
167. Neurologically Adaptive and Responsive Interfacing—Upgraded Space Key with Automatic Detection of Word Spacing and Sentence Construction for Faster Custom Messaging
168. Neurologically Adaptive and Responsive Interfacing—Upgraded Break/Return Key with Automatic Detection of Sentence Construction for Faster Custom Messaging
169. Neurologically Adaptive and Responsive Interfacing—Upgraded Integration with External Artificial Intelligence Personal Assistant via Automatic Speech Synthesizing from Custom Messaging
170. Neurologically Adaptive and Responsive Interfacing—Upgraded Word Selection via Predictive Dictionary Scanning
171. Neurologically Adaptive and Responsive Interfacing—Upgraded Word Selector from Predictive Dictionary Scanning
172. Neurologically Adaptive and Responsive Interfacing—Upgraded Keyboard Radar with 360 Degree Selection by Oscillation
173. Neurologically Adaptive and Responsive Interfacing—Upgraded Keyboard Radar with Predictive Word Selection
174. Neurologically Adaptive and Responsive Interfacing—Upgraded Keyboard Radar with Predictive Dictionary Module
175. Neurologically Adaptive and Responsive Interfacing—Upgraded Keyboard Radar with Selection by Oscillation based on User Accuracy and Constant Monitoring of Neurological Data with additional Alpha-Numerical Module
176. Neurologically Adaptive and Responsive Interfacing—Upgraded Keyboard Radar with Selection by Oscillation based on User Accuracy and Constant Monitoring of Neurological Data with additional Alpha-Numerical Module
177. Neurologically Adaptive and Responsive Interfacing—Upgraded Keyboard Radar with Selection by Oscillation based on User Accuracy and Constant Monitoring of Neurological Data with additional Alpha-Numerical Module
178. Neurologically Adaptive and Responsive Interfacing—Example of a 4-bit responsive interface for the computer operating system
179. Neurologically Adaptive and Responsive Interfacing—Example of a 9-bit responsive interface for the computer operating system
180. Neurologically Adaptive and Responsive Interfacing—Example of a 12-bit responsive interface for the computer operating system

### REFERENCES

The following are hereby incorporated in their entirety by this reference.
Patents: KR20180036503; CN106681494; CN104360730; CN103845137; CN103543836; CN102866775; CN102184018; CN102129307; CN101968715; US20170329404 A1; US2012245713; US2008235164; WO2014142962; WO9721165.

### Non-Patent Literature

S. U. Rehman; A. M. Kamboh; Y. Yang et al. International Conference on Applied Electronics (AE), p. 1-4, 2017, 8-channel neural signal recording front-end integrated circuit.
B. Sumak; M. Spindler; M. Pusnik et al. 40th International Convention on Information and Communication Technology, Electronics and Microelectronics (MIPRO), p. 576-581, 2017, Design and development of contactless interaction with computers based on the Emotiv EPOC+ device.
B. Jagadish; M. P. R. S. Kiran; P. Rajalakshmi et al. IEEE 19th International Conference on e-Health Networking, Applications and Services (Healthcom), p. 1-5, 2017, A novel system architecture for brain controlled IoT enabled environments.
L. Goldsberry; W. Huang; N. F. Wymbs; S. T. Grafton; D. S. Bassett; A. Ribeiro et al. IEEE International Conference on Acoustics, Speech and Signal Processing (ICASSP), p. 851-855, 2017, Brain signal analytics from graph signal processing perspective.
P. Wang; J. Lu; B. Zhang; Z. Tang et al. 5th International Conference on Information Science and Technology (ICIST), p. 315-322, 2015, A review on transfer learning for brain-computer interface classification.
J. Tripathi; R. S. Tomar; S. Akashe et al. International Conference on Communication Networks (ICCN), p. 223-227, 2015, Neural signal front-end amplifier in 45 nm technology.
J. C. Chung; W. M. Chen; C. Y. Wu et al. IEEE International Symposium on Circuits and Systems (ISCAS), p. 1234-1237, 2015, An 8-channel power-efficient time-constant-enhanced analog front-end amplifier for neural signal acquisition.
E. Diana Teran Mejia; E. C. B. Vilca et al. IEEE ANDESCON, p. 1, 2014, Brain signals acquired using a modular encephalograph for digital processing and BCI application.
H. Sepehrian; B. Gosselin et al. 36th Annual International Conference of the IEEE Engineering in Medicine and Biology Society, p. 5284-5287, 2014, A low-power current-reuse dual-band analog front-end for multi-channel neural signal recording.
Connolly, John F et al. IEEE International Conference on Robotics and Automation, 2013, Thought-controlled robots—Systems, studies and future challenges.
K. S. Hong; H. Santosa et al. International Conference on Robotics, Biomimetics, Intelligent Computational Systems, p. 1-4, 2013, Current BCI technologies in brain engineering.
D. Hua; Z. Lei; C. Zhiming; G. Xiaoyan; W. Xinghua et al. IEEE International Conference on Green Computing and Communications and IEEE Internet of Things and IEEE Cyber, Physical and Social Computing, p. 1817-1819, 2013, Circuit Design of Analog Front-End for Neural Signal Detection.
A. T. Do; C. K. Lam; Y. S. Tan; K. S. Yeo; J. H. Cheong; X. Zou; L. Yao; K. W. Cheng; M. Je et al. 10th IEEE International NEWCAS Conference, p. 525-528, 2012, A 160 nW 25 kS/s 9-bit SAR ADC for neural signal recording applications.
C. Matlack; C. Moritz; H. Chizeck et al. Annual International Conference of the IEEE Engineering in Medicine and Biology Society, p. 1699-1702, 2012, Applying best practices from digital control systems to BMI implementation.
J. Mountney; D. Silage; I. Obeid et al. Annual International Conference of the IEEE Engineering in Medicine and Biology, p. 2674-2677, 2010, Parallel field programmable gate array particle filtering architecture for real-time neural signal processing.
P. Rattanatamrong; A. Matsunaga; P. Raiturkar; D. Mesa; M. Zhao; B. Mahmoudi; J. DiGiovanna; J. Principe; R. Figueiredo; J. Sanchez; J. Fortes et al. Annual International Conference of the IEEE Engineering in Medicine and Biology, p. 4339-4342, 2010, Model development, testing and experimentation in a CyberWorkstation for Brain-Machine Interface research.
M. T. Wolf*; J. W. Burdick et al. IEEE Transactions on Biomedical Engineering, Vol. 56, No. 11, p. 2649-2659, 2009, A Bayesian Clustering Method for Tracking Neural Signals Over Successive Intervals.
T. Yoshida; Y. Masui; R. Eki; A. Iwata; M. Yoshida; K. Uematsu et al. IEEE International Symposium on Circuits and Systems, p. 661-664, 2009, A neural signal detection amplifier with low-frequency noise suppression.
D. H. Goldberg; A. G. Andreou et al. Neural Computation, Vol. 19, No. 10, p. 2797-2839, 2007, Distortion of Neural Signals by Spike Coding.
C. L. Rogers; J. G. Harris; J. C. Principe; J. C. Sanchez et al. 3rd International IEEE/EMBS Conference on Neural Engineering, p. 490-493, 2007, A Pulse-Based Feature Extractor for Spike Sorting Neural Signals.
K. Mathieson; S. Kachiguine; C. Adams; W. Cunningham; D. Gunning; V. O'Shea; K. M. Smith; E. J. Chichilnisky; A. M. Litke; A. Sher; M. Rahman et al. IEEE Transactions on Nuclear Science, Vol. 15, No. 5, p. 2027-2031, 2004, Large-area microelectrode arrays for recording of neural signals.
N. F. Ramsey; M. P. van de Heuvel; K. H. Kho; F. S. S. Leijten et al. IEEE Transactions on Neural Systems and Rehabilitation Engineering, Vol. 14, No. 2, p. 214-217, 2006, Towards human BCI applications based on cognitive brain systems: an investigation of neural signals recorded from the dorsolateral prefrontal cortex.
R. N. Vigario et al. Conference Proceedings of the 23rd Annual International Conference of the IEEE Engineering in Medicine and Biology Society, Vol. 2, p. 1970-1973, 2001, From principal to independent component analysis of brain signals.
Grants:
DeKoninck, Yves et al. Université Laval, Discovery Grants Program—Individual, Tools to decipher neuronal signaling and computation, 2016-2017.
Plourde, Eric et al. Université de Sherbrooke, John R. Evans Leaders Fund—Funding for research infrastructure/Fonds des leaders John R. Evans—Financement de l'infrastructure de recherche, Multichannel neural signal recording instrumentation for the central auditory system, 2015-2016.
Genov, Roman et al. University of Toronto, Collaborative Health Research Projects (NSERC), Fully implantable wireless multi-electrode ECoG monitoring system, 2014-2015.
Connolly, John F et al. McMaster University, Engage Grants Program, Taking AIM: Development of an Alternative Interactive Modality for gaming and other digital media applications, 2013-2014.
Cook, Erik et al. McGill University, Research Tools and Instruments—Category 1 (<$150,000), Multichannel neural recordings: high resolution snapshots of cortical computation, 2012-2013.

### Classifications

G06F3/00 Input arrangements for transferring data to be processed into a form capable of being handled by the computer; Output arrangements for transferring data from processing unit to output unit, e.g. interface arrangements
G06F3/01 Input arrangements or combined input and output arrangements for interaction between user and computer
G06F3/015 Input arrangements based on nervous system activity detection, e.g. brain waves (EEG) detection, electromyograms (EMG) detection, electrodermal response detection
G06F3/048 Interaction techniques based on graphical user interfaces [GUI]
A61M2230/10 Electroencephalographic signals
A61M2230/14 Electrooculogram [EOG]
A61B5/0482 Electroencephalography using biofeedback
A61B5/0488 Electromyography
A61B5/04012 Analysis of electrocardiograms, electroencephalograms, electromyograms
A61B5/4064 Evaluating the brain
A61B5/0024 Remote monitoring of patients using telemetry, e.g. transmission of vital signals via a communication network characterised by features of the telemetry system for multiple sensor units attached to the patient, e.g. using a body or personal area network

1-2. (canceled)

3. A method to use human brain-based neurological signals to control a computer operating system.

4-6. (canceled)

7. The method of claim 3, further comprising: processing, filtering and classifying neural commands from a human brain into active computer commands for the neurologically-based functioning of a computer operating system.

8-9. (canceled)

10. The method of claim 3, wherein an end-user uses human brain-based neurological signals to perform at least one of: downloading external computer data, and/or downloading or digitally streaming and subsequently playing a music or video data file into the computer operating system, a computer hardware application or a computer software application.

11-13. (canceled)

14. The method of claim 3, wherein the computer operating system is configured to receive human brain-based neurological signals and broadcast and communicate, via the use of the computer operating system, the user's state of at least one of physical health, mental health, cognitive alertness, mental stress, fear, and/or physiological description of one or more sudden injuries to another user or another computer operating system, computer hardware and/or computer software application.

15-19. (canceled)

20. The method of claim 3, wherein the operating system is configured to receive human brain-based neurological signals to alert another user or another computer operating system of an algorithmically-predicted variable state of potential to immediate danger.

21. The method of claim 3, wherein the operating system is configured to receive human brain-based neurological signals to communicate with another user utilizing at least one of a neurologically-controlled embedded live video-conferencing software application, and embedded pre-recorded audio-visual messages.

22. (canceled)

23. The method of claim 3, wherein an end-user is capable of using human brain-based neurological signals to control and operate the computer operating system by locating pre-programmed computer code and targeting and launching the technical execution of said code via the use of an embedded neurologically-controlled digital radar computer code-locating interface.

24. The method of claim 3 wherein an end-user is capable of using human brain-based neurological signals via the use of the computer operating system to communicate with another user by utilizing a virtual keyboard to type a text message with a non-assisted, non-archived, non-predictive, non-P300 Event-Related Potential Brain-to-Computer Interface system for slower conventional character spelling method, said virtual keyboard being f neurologically-controlled by an embedded digital radar letter-locating interface.

25. The method of claim 3, wherein an end-user is capable of using human brain-based neurological signals via the use of the computer operating system to communicate with another user by utilizing a virtual keyboard to type a digitally-assisted predictive text-based message with a non-P300 Brain-to-Computer Interface system for character spelling method, said keyboard being neurologically-controlled by an embedded digital radar letter-locating and word-locating interface.

26. The method of claim 3, wherein the computer operating system is controlled by human brain-based neurological signals to locate, select, prioritize, schedule, organize, store and display independently in the computer user interface via machine-learning algorithms external content in a digital form to an end-user based on at least one of end-user demographic data, pattern recognitions by the computer operating system navigation by the end-user, pattern recognitions by the computer operating system usage trends by the end-user, frequency and repetition levels of historically-identical or similarly-accessed content by the end-user, physical health of the end-user at the time of interaction between the end-user and the computer operating system, mental health of the end-user at the time of interaction between the end-user and the computer operating system, and/or end-user preferences and end-user demographic data.

27-36. (canceled)

37. The method of claim 3, wherein the computer operating system is controlled by human brain-based neurological signals to allow an end-user to communicate with another user remotely located to receive at least one of technical support or expert professional advice, emergency medical assistance, emergency medical transportation assistance, emergency police assistance, and/or emergency firefighting assistance.

38-41. (canceled)

42. The method of claim 3, wherein the computer operating system controlled by human brain-based neurological signals allows an end-user to at least one of: log in to an online social media messaging platform to interact with other users; log in to an online live videoconferencing platform; access video and/or audio content; access of control software gaming applications; access or control an internet web browser application; access or control home-based automations; and/or access financial records and/or initiate financial transactions.

43-50. (canceled)

51. The method of claim 3, whereby the computer operating system controlled by human brain-based neurological signals has a graphic computer interface controlled by the interactive positioning and the interactive execution of computer code represented by a graphic or set of graphics linearly or radially moving or translating within a graphical grid-like representation of the computer operating system's graphic user interface or parts thereof.

52. The method of claim 3, whereby a computer operating system controlled by human brain-based neurological signals has a graphical grid-like representation of the computer operating system's graphic user interface or parts thereof acting as a two-dimensional receptor of a computer code execution.

53. The method of claim 3, whereby the computer operating system controlled by human brain-based neurological signals has a two-dimensional receptor of a code execution in the graphical form of a grid whereas each cell of the grid is an independent physical area able to be activated by the original code execution and subsequently generate an automatic secondary subroutine nested code execution, itself capable of launching and executing further subroutine nested code executions either processed locally by the computer operating system or the computer operating system's graphic user interface or processed externally by other third-party independent electronic systems upon receipt.

54. The method of claim 3, whereby the computer operating system controlled by human brain-based neurological signals has the ability to discern or prioritize a code execution initiated by an interaction between two or more graphical elements by calculating the mathematical difference and/or the physical distance between each of the geometrical centers of the graphical elements within the computer operating system's graphical user interface.

55. The method of claim 3, wherein the computer operating system is configured to determine over time specific trends via machine learning techniques, including filtering neurological data via at least one of artificial neural networks, mathematical or waveform algorithmic analysis, or specific signature extraction, wherein the neurological data includes at least one of electroencephalography data and/or electrooculography data.

56. The method of claim 3, wherein the computer operating system is configured to modify its functionality over time based on a determination of specific trends via machine learning techniques, said machine learning techniques including filtering neurological data via at least one of artificial neural networks, mathematical or waveform algorithmic analysis, or specific signature extraction, wherein the neurological data includes at least one of electroencephalography data and/or electrooculography data.

57. A computing device comprising:
a processor; and
a memory having stored thereon computer-executable instructions that, when executed by the processor, cause the processor to use human brain-based neurological signals to control a computer operating system.

58. A non-transitory computer-readable storage medium having stored thereon processor-executable instructions that, when executed by a processor, cause the processor to use human brain-based neurological signals to control a computer operating system.
